(19) United States
(12) Patent Application Publication
(10) Pub. No.: US 2010/0188679 A1
(43) Pub. Date: Jul. 29, 2010

(54) DOCUMENT IMAGE DATA PRINTING SYSTEM

(76) Inventor: Chisa NAKAGAWA, Osaka-shi (JP)

Correspondence Address: BIRCH STEWART KOLASCH & BIRCH, PO BOX 747, FALLS CHURCH, VA, 22040-0747, US

(21) Appl. No.: 12/693,112

(22) Filed: Jan. 25, 2010

(30) Foreign Application Priority Data
Jan. 26, 2009 (JP) 2009-014734

(51) Int. Cl. G06K 15/00

(52) U.S. Cl. 358/1.12

(57) ABSTRACT

A page turning direction specifying screen page is displayed for allowing a user to select a page turning direction of a document, i.e., a printed material. Then, based on the page turning direction selected, predetermined layout examples of page images are narrowed down so that the user makes a selection from the layout example(s) thus narrowed down. With this, even a user unfamiliar with the apparatus can easily carry out operation for printing and outputting, in an easy-to-see form, page image data arranged in order of page numbers, with a function(s) of e.g., N in 1 printing, two-sided printing, and/or printing with binding margin function. Thus, a user-friendly document image data printing system is provided.

This Nonprovisional application claims priority under 35 U.S.C. §119(a) on Patent Application No. 2009-014734 filed in Japan on Jan. 26, 2009, the entire contents of which are hereby incorporated by reference.

### TECHNICAL FIELD

The present invention relates to a document image data printing system, provided in an image processing system (e.g., MFP) having a printing function, for carrying out a printing process with respect to page image data, which are image data of respective pages and are arranged in order of page numbers.

### BACKGROUND ART

Advanced printing, e.g., saddle stitch printing and N in 1 printing (“N” is a natural number of 2 or greater) such as 2 in 1 printing, can be carried out by (i) recent multifunctional printing apparatuses such as the one called MFP (Multi Function Peripheral) or multifunction printer and (ii) recent printing apparatuses used as peripheral equipment of personal computers.

The “N in 1 printing” refers to a printing technique by which one surface of one sheet is divided into N regions and a content corresponding to one page of papers (document) is printed on one of the N regions. That is, by 2 in 1 printing, contents corresponding to two pages are printed on one surface of one recording sheet; by 4 in 1 printing, one surface of one recording sheet is divided into four regions, and contents corresponding to four pages of the papers are respectively printed on the four regions.

The “saddle stitch printing” refers to a printing technique for printing images on one or more sheets, which are then folded in half and stitched up at its folding margin, serving as a binding margin, so as to create a form such as a booklet, a pamphlet, or a magazine. Thus, contents corresponding to two pages are printed on each surface of a sheet. The “saddle stitch printing” offers the following options: right-to-left page turning in which a binding margin is located along the left vertical side edge of half-folded sheet(s) and the pages are turned from right to left; left-to-right page turning in which a binding margin is located along the right vertical side edge of half-folded sheet(s) and the pages are turned from left to right; and upward page turning in which a binding margin is located along the top horizontal side edge of half-folded sheet(s) and the pages are turned from down to up.

Thus, recent printing apparatuses can carry out printing while arranging pages in various forms.

Further, in addition to N in 1 printing and saddle stitch printing, some of the multifunctional printing apparatuses such as the one called MFP and the printing apparatuses used as peripheral equipment of personal computers have printing functions such as two-sided printing and printing with binding margin function by which a binding margin is created along one side of a sheet.

By the two-sided printing, images are respectively created on both surfaces of a sheet. The two-sided printing offers, according to a direction along which a two-sided printed material is bound, the following three options: right-to-left page turning, left-to-right page turning, and upward page turning. In a case of right-to-left page turning or left-to-right page turning, upside directions of images on both surfaces of a sheet are the same. On the other hand, in a case of upward page turning, upside directions of images on both surfaces of a sheet are reverse to each other.

By printing with binding margin function, an image is slightly reduced and the position of the image on the sheet is shifted so that a binding margin is secured. Note that two-sided printing, printing with binding margin function, and N in 1 printing can be used in any combination.

### Citation List

Patent Literature 1: Japanese Patent Application Publication, Tokukaihei, No. 11-99724 A (Publication Date: Apr. 13, 1999)

### SUMMARY OF INVENTION

### Technical Problem

However, the above-described conventional configurations do not allow a user to select a page turning direction of papers (i.e., a printed material) to be obtained, in the process of N in 1 printing, two-sided printing, and/or printing with binding margin function (in which a binding margin is created along one side of a sheet(s)) carried out on page image data arranged in order of page numbers. Therefore, the following case may happen: Only after a user checks the printed material in his/her hands, he/she notices that the page images are not arranged suitably for the page turning direction and/or that the page images are in a layout with which the page images cannot be seen properly. In such a case, the user must carry out printing all the way again. Thus, the above-described conventional configurations have a problem of poor usability.

### Solution to Problem

The present invention was made in view of the foregoing problem, and an object of the present invention is to provide a user-friendly document image data printing system with which even a user unfamiliar with the apparatus can easily carry out operation for printing and outputting, in an easy-to-see form, page image data arranged in order of page numbers, with a function(s) of e.g., N in 1 printing, two-sided printing, and/or printing with binding margin function.

In order to solve the foregoing problem, a first document image data printing system of the present invention is a document image data printing system for carrying out a printing process with respect to document image data including page image data arranged by page numbers, each of the page image data being image data corresponding to one page, said document image data printing system comprising: page turning direction selecting means for allowing a user to select a page turning direction of a printed material to be obtained through the printing process with respect to the document image data; and page image layout selecting means for extracting, based on the page turning direction selected through the page turning direction selecting means, at least one layout example from predetermined layout examples as a candidate, with respect to a printing form for which a layout of at least one page image on a sheet is selected from among the predetermined layout examples, so as to allow the user to select, from said at least one layout example extracted, a layout example based on which the printing process is to be carried out.

In this configuration, the page turning direction selecting means allows the user to select the page turning direction of the printed material to be obtained through the printing process with respect to the document image data. The user can select, as the page turning direction, any one of right-to-left page turning, left-to-right page turning, and upward page turning, for example. Further, based on the page turning direction specified through the page turning direction selecting means, the page image layout selecting means extracts at least one candidate from the predetermined layout examples with respect to the printing form for which the layout of at least one page image on the sheet is selected from the predetermined layout examples. Then, the page image layout selecting means allows the user to select a layout example from said at least one candidate extracted.

For the printing form for which the layout of the page images on the sheet is selected from among the predetermined layout examples, some layout examples may be unsuitable for a certain page turning direction. There may be a case where a user unfamiliar with the apparatus selects such the unsuitable layout example, thereby causing printing failure.

In the present invention, the page image layout selecting means extracts, based on the page turning direction selected, at least one candidate from the predetermined layout examples, so as to allow the user to select a layout example from the extracted one(s). This prevents selection of the unsuitable layout example, thereby avoiding printing failure.

In order to solve the foregoing problem, a second document image data printing system of the present invention is a document image data printing system for carrying out a printing process with respect to document image data including page image data arranged by page numbers, each of the page image data being image data corresponding to one page, said document image data printing system comprising: page turning direction selecting means for allowing a user to select a page turning direction of a printed material to be obtained through the printing process with respect to the document image data; page image layout selecting means for extracting, based on the page turning direction selected through the page turning direction selecting means, at least one layout example from predetermined layout examples as a candidate, with respect to a printing form for which a layout of at least one page image on a sheet is selected from among the predetermined layout examples, so as to allow the user to select, from said at least one layout example extracted, a layout example based on which the printing process is to be carried out; and preview image display controlling means for causing a display section to display a preview image based on the page image data, the preview image corresponding to the printing form and showing at least one page image and said at least one layout example extracted by the page image layout selecting means.

According to this, in addition to an effect obtained by the first document image data printing system, the following effect can be obtained: The preview image display controlling means causes, based on the page image data, the display section to display the preview image corresponding to the printing form and showing at least one page image and said at least one layout example extracted by the page image layout selecting means. With this, before the printing is actually executed, the user can see the preview image and obtain a printing result in an image. Therefore, even a user unfamiliar with the apparatus can easily obtain a printed material as desired.

Examples of the printing form for which the layout of at least one page image on the sheet is selected from among the predetermined layout examples encompass: N in 1 printing by which page images corresponding to N pages are arranged on one sheet; two-sided printing by which page images are respectively formed on both surfaces of a sheet; and printing with binding margin function by which a page image is formed on a sheet while a binding margin is secured along a side edge of the sheet.

### ADVANTAGEOUS EFFECTS OF INVENTION

With the above-described configuration, it is possible to provide a user-friendly document image data printing system with which even a user unfamiliar with the apparatus can easily carry out operation for printing and outputting, in an easy-to-see form, page image data arranged in order of page numbers, with a function(s) of e.g., N in 1 printing, two-sided printing, and/or printing with binding margin function.

### BRIEF DESCRIPTION OF DRAWINGS

FIG. 1 is a functional block diagram illustrating a function of an image forming apparatus of one embodiment to which a document image data input system of the present invention is applied.

FIG. 2 is a view schematically illustrating the whole of a configuration of the image forming apparatus.

FIG. 3 is a block diagram illustrating an example of a configuration of hardware constituting the image forming apparatus.

FIG. 4 is a plan view illustrating an operation panel of the image forming apparatus.

FIG. 5 is a flow chart of a process, carried out by the image forming apparatus, in which a saddle-stitch document is scanned and then is copied or sent in another form.

FIG. 6 is an explanatory diagram of a scanning start surface specifying screen page with a preview, which is displayed on an operation panel of the image forming apparatus. The scanning start surface specifying screen page includes a preview image of a scanned document image, and allows a user to specify whether the document has been scanned from its front cover/back cover or its center.

FIG. 7 is an explanatory diagram of a page turning direction specifying screen page with a preview, which is displayed on the operation panel of the image forming apparatus. The page turning direction specifying screen page includes a preview image of a scanned document image, and allows a user to specify whether the saddle-stitch document is of right-to-left page turning, left-to-right page turning, or upward page turning.

FIG. 8 is an explanatory diagram of a rotation process selecting screen page with a preview, which is displayed on the operation panel of the image forming apparatus. The rotation process selecting screen page allows a user to select a rotation process for correction of an orientation of an image scanned from the saddle-stitch document.

FIG. 9 is an explanatory diagram of an editing process selecting screen page with a preview, which is displayed on the operation panel of the image forming apparatus. The editing process selecting screen page includes a preview of a first page image of the sorted page images, and allows a user to select an editing process.

FIG. 10 is an explanatory diagram of a layout selecting screen page with a preview, which is displayed on the operation panel of the image forming apparatus. The layout selecting screen page allows a user to select a layout for 2 in 1.

FIG. 11 is an explanatory diagram of a layout selecting screen page with a preview, which is displayed on the operation panel of the image forming apparatus. The layout selecting screen page allows a user to select a layout for 4 in 1.

FIG. 12 is an explanatory diagram of a two-sided printing direction selecting screen page with a preview, which is displayed on the operation panel of the image forming apparatus. The two-sided printing direction selecting screen page allows a user to select a direction for two-sided printing.

FIG. 13 is an explanatory diagram of a binding margin position selecting screen page with a preview, which is displayed on the operation panel of the image forming apparatus. The binding margin position selecting screen page allows a user to select a position in which a binding margin is to be created.

FIG. 14 is an explanatory diagram illustrating how an editing process for “binding margin” is carried out in the image forming apparatus.

FIG. 15 is an explanatory diagram illustrating examples of a process carried out by the image forming apparatus in a case where a right-to-left-page-turning saddle-stitch document, a left-to-right-page-turning saddle-stitch document, or an upward-page-turning saddle-stitch document, placed on a document set tray, is scanned from its front cover/back cover surface.

FIG. 16 is an explanatory diagram illustrating examples of a process carried out by the image forming apparatus in a case where a right-to-left-page-turning saddle-stitch document, a left-to-right-page-turning saddle-stitch document, or an upward-page-turning saddle-stitch document, placed on the document set tray, is scanned from its center surface.

FIG. 17 is an explanatory diagram illustrating examples of a process carried out by the image forming apparatus in a case where a right-to-left-page-turning saddle-stitch document, a left-to-right-page-turning saddle-stitch document, or an upward-page-turning saddle-stitch document, each of which includes a half-size document sheet and placed on the document set tray, is scanned from its front cover/back cover surface.

FIG. 18 is an explanatory diagram illustrating examples of a process carried out by the image forming apparatus in a case where a right-to-left-page-turning saddle-stitch document, a left-to-right-page-turning saddle-stitch document, or an upward-page-turning saddle-stitch document, each of which includes a half-size document sheet and is placed on the document set tray, is scanned from its center surface.

FIG. 19, related to the image forming apparatus, is an explanatory diagram listing items involving a case where a right-to-left-page-turning saddle-stitch document is scanned from its front cover/back cover surface. Specifically, as such items, FIG. 19 shows (i) a scanning start image displayed in a preview image, (ii) a whole scanning result, (iii) “page turning direction”, “scanning start surface”, and “rotation process”, which are conditions selected by a user, and (iv) how to carry out separation, rotation, and sorting based on the conditions selected.

FIG. 20, related to the image forming apparatus, is an explanatory diagram listing items involving a case where a left-to-right-page-turning saddle-stitch document is scanned from its front cover/back cover surface. Specifically, as such items, FIG. 20 shows (i) a scanning start image displayed in a preview image, (ii) a whole scanning result, (iii) “page turning direction”, “scanning start surface”, and “rotation process”, which are conditions selected by a user, and (iv) how to carry out separation, rotation, and sorting based on the conditions selected.

FIG. 21, related to the image forming apparatus, is an explanatory diagram listing items involving a case where an upward-page-turning saddle-stitch document is scanned from its front cover/back cover surface. Specifically, as such items, FIG. 21 shows (i) a scanning start image displayed in a preview image, (ii) a whole scanning result, (iii) “page turning direction”, “scanning start surface”, and “rotation process”, which are conditions selected by a user, and (iv) how to carry out separation, rotation, and sorting based on the conditions selected.

FIG. 22, related to the image forming apparatus, is an explanatory diagram listing items involving a case where a right-to-left-page-turning saddle-stitch document including a half-size document sheet is scanned from its front cover/back cover surface. Specifically, as such items, FIG. 22 shows (i) a scanning start image displayed in a preview image, (ii) a whole scanning result, (iii) “page turning direction”, “scanning start surface”, and “rotation process”, which are conditions selected by a user, and (iv) how to carry out separation, rotation, and sorting based on the conditions selected.

FIG. 23, related to the image forming apparatus, is an explanatory diagram listing items involving a case where a left-to-right-page-turning saddle-stitch document including a half-size document sheet is scanned from its front cover/back cover surface. Specifically, as such items, FIG. 23 shows (i) a scanning start image displayed in a preview image, (ii) a whole scanning result, (iii) “page turning direction”, “scanning start surface”, and “rotation process”, which are conditions selected by a user, and (iv) how to carry out separation, rotation, and sorting based on the conditions selected.

FIG. 24, related to the image forming apparatus, is an explanatory diagram listing items involving a case where an upward-page-turning saddle-stitch document including a half-size document sheet is scanned from its front cover/back cover surface. Specifically, as such items, FIG. 24 shows (i) a scanning start image displayed in a preview image, (ii) a whole scanning result, (iii) “page turning direction”, “scanning start surface”, and “rotation process”, which are conditions selected by a user, and (iv) how to carry out separation, rotation, and sorting based on the conditions selected.

FIG. 25, related to the image forming apparatus, is an explanatory diagram showing, (i) selectable forms, (ii) a page turning direction, (iii) a default determined by the page turning direction, and (iv) forms narrowed down by the page turning direction, in connection with processes of “2 in 1” and “4 in 1” to be carried out after sorting.

FIG. 26, related to the image forming apparatus, is an explanatory diagram illustrating, (i) selectable forms, (ii) a page turning direction, (iii) a default determined by the page turning direction, and (iv) forms narrowed down by the page turning direction, in connection with processes of “two-sided printing” and “binding margin” to be carried out after sorting.

FIG. 27 is an explanatory diagram of a page image layout selecting screen page with a preview, which is displayed on the operation panel of the image forming apparatus. The page image layout selecting screen page narrows down layouts for 2 in 1 so as to allow a user to select, from the layout(s) thus narrowed down, one which is suitable for the page turning direction selected.

FIG. 28 is an explanatory diagram of a page image layout selecting screen page with a preview, which is displayed on the operation panel of the image forming apparatus. The page image layout selecting screen page narrows down layouts for 4 in 1 so as to allow a user to select, from the layout(s) thus narrowed down, one which is suitable for the page turning direction selected.

FIG. 29 is a view illustrating another embodiment of the present invention, and schematically illustrating a configuration of the whole of an image forming apparatus.

### DESCRIPTION OF EMBODIMENTS

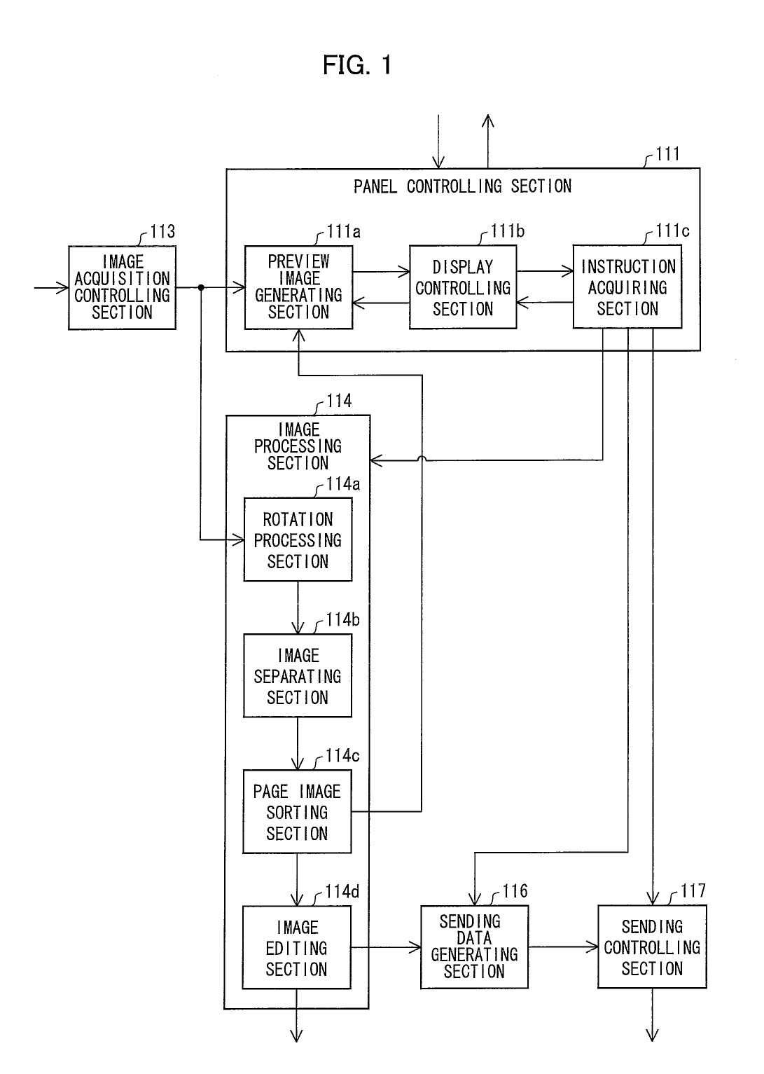

One embodiment of the present invention is described below with reference to FIG. 1 through FIG. 28.

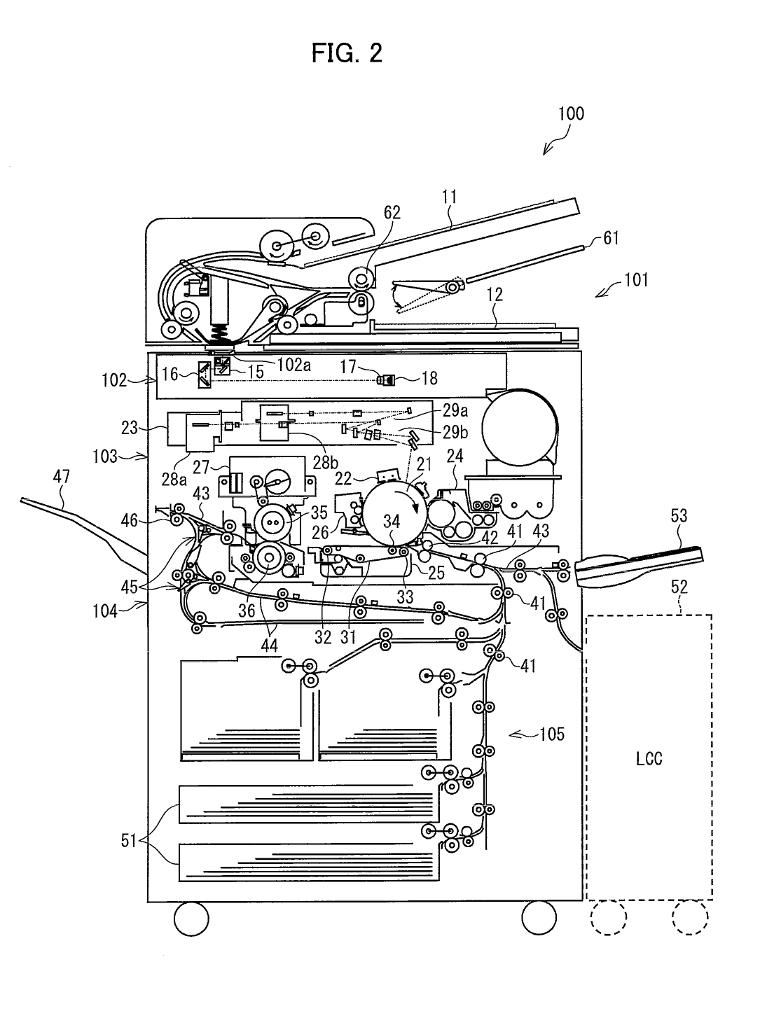

FIG. 2 is a view schematically illustrating a configuration of the whole of an image forming apparatus (digital Multi Function Peripherals; MFP) of one embodiment, to which a document image data input system of the present invention is applied.

This image forming apparatus 100 acquires (i) image data scanned from a document sheet or (ii) image data externally received, and forms, on a recording sheet, a monochrome image indicated by the image data thus acquired. The configuration of the image forming apparatus 100 is roughly classified into: a document carrying section 101 including an automatic document feeder (ADF); an image scanning section 102 including a scanner unit; a printing section 103 including a printing unit; a recording sheet carrying section 104; and a sheet feeding section 105.

In the document carrying section 101, the following operation is carried out: When one or more document sheets are placed on a document set tray 11, the document sheets are drawn one by one from an uppermost one. The document sheet thus drawn is carried to a document scanning window 102a in the image scanning section 102, and is caused to pass through the document scanning window 102a. In a case where the document sheet is one-sided, the document sheet which has passed through the document scanning window 102a is discharged face down to a paper output tray 12.

On the other hand, in a case where the document sheet is two-sided, the document sheet which has passed through the document scanning window 102a is discharged halfway to a middle tray 61 disposed above the paper output tray 12. Then, at the point that a rear edge of the document sheet reaches a paper output roller 62, the paper output roller 62 is rotated in a reverse direction so that the document sheet is carried in a switchback manner and is led to the document scanning window 102a again. Then, the document sheet is discharged to the paper output tray 12.

In the image scanning section 102 the following operation is carried out: While the document sheet is passing through the document scanning window 102a, a surface of the document sheet is exposed to light by a lamp of a first scanning unit 15. Then, light reflected by the surface of the document sheet is led to an image focusing lens 17 by mirrors in first and second scanning units 15 and 16, so that the image focusing lens 17 forms, on a CCD (Charge Coupled Device) 18, an image depicted on the surface of the document sheet. The CCD 18 repeatedly scans, along a main scanning direction, the image depicted on the surface of the document sheet, so as to output image data indicative of the image depicted on the surface of the document sheet.

In a case where a document sheet is placed on a platen glass provided on a top of the image scanning section 102, the first and second scanning units 15 and 16 are caused to move while a predetermined relationship of speed therebetween is maintained. Then, a surface of the document sheet on the platen glass is exposed to light by the first scanning unit 15, and light reflected by the surface of the document sheet is led to the image focusing lens 17 by the first and second scanning units 15 and 16. Then, the image focusing lens 17 forms, on the CCD 18, an image depicted on the surface of the document sheet.

The image data outputted from the CCD 18 is subjected to various kinds of image processing by a control circuit such as a microcomputer, and then is outputted to the printing section 103.

The printing section 103 records, on a sheet, an image of the document sheet indicated by the image data. Further, the printing section 103 includes a photoreceptor drum 21, a charger 22, an optical writing unit 23, a developer 24, a transfer unit 25, a cleaning unit 26, and a fixing unit 27, for example.

The photoreceptor drum 21 rotates in one direction. After a surface of the photoreceptor drum 21 is cleaned up by the cleaning unit 26, the surface is uniformly charged by the charger 22. The charger 22 may be a non-contact type, or may be a roller type or a brush type each of which is in contact with the photoreceptor drum 21.

The optical writing unit 23 is a laser scanning unit (LSU) including: two laser emitting sections i.e., laser emitting sections 28a and 28b; and two mirror groups i.e., mirror groups 29a and 29b. Image data is inputted to the optical writing unit 23, and each of the laser emitting sections 28a and 28b emits laser light according to the image data thus inputted. The laser light is irradiated onto the photoreceptor drum 21 via the mirror groups 29a and 29b, so that the surface of the photoreceptor drum 21 which is uniformly charged is exposed to the light. Thus, an electrostatic latent image is formed on the surface of the photoreceptor drum 21.

For high-speed printing processing, the optical writing unit 23 employs a two-beam method using the two laser emitting sections i.e., the laser emitting sections 28a and 28b. This eases a burden of shortened irradiation timings.

Instead of the laser scanning unit, the optical writing unit 23 may be an EL writing head or an LED writing head, in each of which light-emitting elements are arranged in an array.

The developer 24 supplies toner to the surface of the photoreceptor drum 21, and develops the electrostatic latent image, so that a toner image is formed on the surface of the photoreceptor drum 21. The transfer unit 25 transfers the toner image thus formed on the surface of the photoreceptor drum 21 onto a recording sheet carried by a sheet carrying section 104. The fixing unit 27 heats and pressurizes the recording sheet so that the toner image is fixed on the recording sheet. Then, the recording sheet is further carried to a sheet output tray 47 by the sheet carrying section 104 so as to be discharged. After the development and transfer, the cleaning unit 26 removes and collects the toner remaining on the surface of the photoreceptor drum 21.

Here, the transfer unit 25 includes a transfer belt 31, a driving roller 32, a driven roller 33, and an elastic conductive roller 34, for example. The transfer belt 31 is suspended by the rollers 32 to 34 and other rollers so as to be rotated. The transfer belt 31 has a predetermined resistance (e.g., 1×10⁹ Ω/cm to 1×10¹³ Ω/cm) to carry the recording sheet placed on a surface of the transfer belt 31. The elastic conductive roller 34 is pressed onto the surface of the photoreceptor drum 21 via the transfer belt 31, so that the recording sheet on the transfer belt 31 is pressed onto the surface of the photoreceptor drum 21. To the elastic conductive roller 34, an electric field having a polarity reverse to a charging polarity of the toner image formed on the surface of the photoreceptor drum 21 is applied, and the electric field having the reverse polarity causes the toner image on the surface of the photoreceptor drum 21 to be transferred onto the recording sheet on the transfer belt 31. For example, in a case where the toner image has an electric potential of a negative (−) polarity, the electric field applied to the elastic conductive roller 34 is set to have a positive (+) polarity.

The fixing unit 27 includes a heat roller 35 and a pressure roller 36. The heat roller 35 internally includes a heat source for setting a temperature of a surface of the heat roller 35 to a predetermined temperature (fixing temperature: approximately 160° C. to 200° C.). Further, pressure members (not illustrated) are provided at both sides of the pressure roller 36 so that the pressure roller 36 is pressed onto the heat roller 35 at a predetermined pressure. When a recording sheet is carried to a pressure area (which is referred to as fixing nip area) between the heat roller 35 and the pressure roller 36, an unfixed toner image on the recording sheet is molten by heat and pressurized while the recording sheet is being carried by the rollers 35 and 36, so that a toner image is fixed on the recording sheet.

The sheet carrying section 104 includes: a plurality of pairs of carrying rollers 41 for carrying a recording sheet; one pair of registration rollers 42; a carrying path 43; a reverse carrying path 44; a plurality of diverging claws 45; and one pair of sheet output rollers 46, for example.

The carrying path 43 receives a recording sheet from the sheet feeding section 105, and carries the recording sheet until a front edge of the recording sheet reaches the registration roller 42. At this time, the registration roller 42 is temporarily stopped. Therefore, when the front edge of the recording sheet reaches and comes in contact with the registration roller 42, the recording sheet is bent. An elastic force of the recording sheet thus bent causes the front edge of the recording sheet to be in parallel with the registration roller 42. After that, the registration roller 42 starts rotating, so as to carry the recording sheet to the transfer unit 25 in the printing section 103. Then, the sheet output roller 46 carries the recording sheet to the sheet output tray 47.

The registration roller 42 is stopped or rotated by turning on/off a clutch provided between the registration roller 42 and its driving shaft or by turning on/off a motor which is a driving source of the registration roller 42.

In a case where an image is to be recorded also on a back surface of the recording sheet, the plurality of diverging claws 45 are rotated to change the destination of the recording sheet from the carrying path 43 to the reverse carrying path 44. Then, the reverse carrying path 44 reverses the front surface and the back surface of the recording sheet. Subsequently, the recording sheet is returned to the registration roller 42 in the carrying path 43 via the reverse carrying path 44. In this manner, an image is formed also on the back surface of the recording sheet.

Each of the carrying path 43 and the reverse carrying path 44 includes, in some portions, sensors for detecting e.g., a position of a recording sheet. According to the position of the recording sheet detected by each sensor, the carrying rollers and the registration rollers are driven. In this way, the recording sheet is carried and positioned.

The sheet feeding section 105 includes a plurality of sheet feeding trays 51. The sheet feeding trays 51 each store recording sheets, and are disposed in a lower portion of the image forming apparatus 100. Further, each of the sheet feeding trays 51 includes e.g., a pickup roller by which recording sheets are drawn one by one, and sends, to the carrying path 43 in the sheet carrying section 104, the recording sheets thus drawn.

Since the image forming apparatus 100 of the present embodiment is designed for high-speed printing processing, the sheet feeding trays 51 each have a capacity capable of storing 500 to 1500 recording sheets of a standard size.

Further, the image forming apparatus 100 is provided with, on a lateral side thereof, (i) a large-capacity paper feeding cassette (LCC) 52 capable of storing a plurality of types of recording sheets in large numbers and (ii) a manual paper feeding tray 53 mainly for feeding a recording sheet of a non-standard size.

The sheet output tray 47 is provided on a lateral side of the image forming apparatus 100 which lateral side is opposite to the lateral side on which the manual paper feeding tray 53 is provided. The sheet output tray 47 may be replaced with (i) a device for post-processing (e.g., stapling, punching) on a discharged sheet or (ii) a sheet output tray of multiple stages.

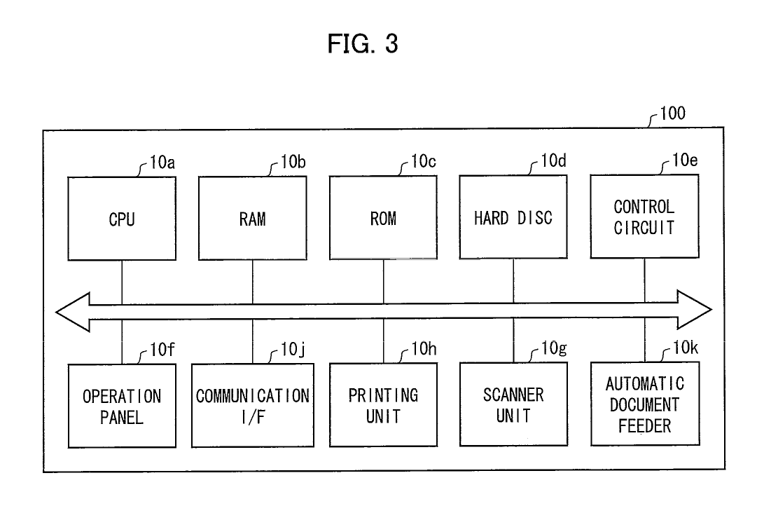

FIG. 3 shows an example of a configuration of hardware constituting the image forming apparatus 100. As shown in FIG. 3, the image forming apparatus 100 includes a CPU 10a, a RAM 10b, a ROM 10c, a hard disc 10d, a control circuit 10e, an operation panel 10f, a scanner unit 10g, a printing unit 10h, a communication interface 10j, and an automatic document feeder 10k, for example.

The control circuit 10e is a circuit for controlling the hard disc 10d, the scanner unit 10g, the printing unit 10h, the communication interface 10j, and the operation panel 10f, for example.

The scanner unit 10g corresponds to the above-described image scanning section 102. The printing unit 10h corresponds to the above-described printing section 103, the above-described recording sheet carrying section 104, and the above-described sheet feeding section 105. The communication interface 10j is an NIC (Network Interface Card) or a modem via which communication with another device is carried out.

The automatic document feeder 10k corresponds to the above-described document carrying section 101. The automatic document feeder 10k sequentially carries one or more document sheets constituting papers, to the scanner unit 10g. Further, the automatic document feeder 10k can deal with a so-called two-sided document sheet. The automatic document feeder 10k reverses a front surface and a back surface of a document sheet. This allows the CCD 18 to scan respective images on the front and back surfaces of the document sheet.

Papers that the image forming apparatus 100 deals with include a document sheet having a surface on which a content is depicted. Such a surface is hereinafter referred to as “document surface”. Generally, such a surface may sometimes be called “printed surface”. There is a case where contents are depicted on both surfaces of a document sheet (i.e., a so-called two-sided document sheet). In such a case, both of the front and back surfaces are document surfaces. Further, there is a case where a content is depicted only on one surface of a document sheet (i.e., a so-called one-sided document sheet). In such a case, said one surface on which the content is depicted is a document surface. Further, an image depicted on the whole of the document surface is referred to as “document surface image”.

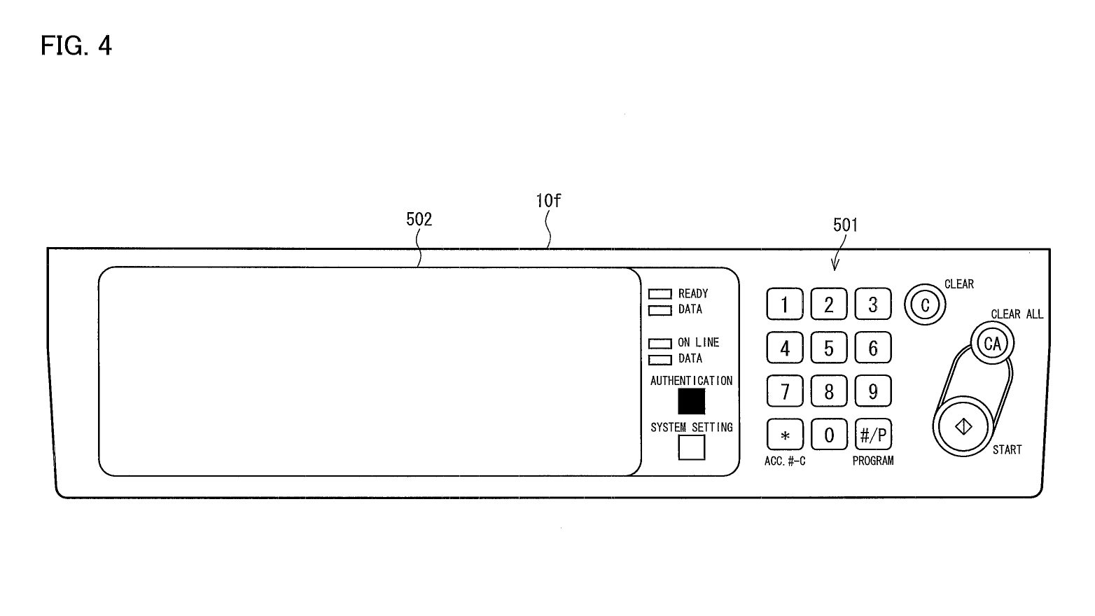

The operation panel 10f includes, as shown in FIG. 4, a key operation section 501 and a display operation section 502. The key operation section 501 includes numeric keys, a start key, a reset key, and a clear key, for example. The display operation section 502 includes a touch panel of a liquid crystal display.

A user can operate the key operation section 501 for (i) giving, to the image forming apparatus 100, a command to e.g., start or interrupt a process, (ii) selecting a process condition (e.g., a destination of data, a printing condition, or a scanning condition), and (iii) specifying other various items.

The display operation section 502 displays e.g., a screen page through which a message or an instruction is given to a user, a screen page through which a user enters a kind of a desired process and a process condition, or a screen page which shows a result of a process carried out by the image forming apparatus 100. A user can enter an instruction by carrying out touch operation in the screen page through which a user enters an instruction as to e.g., a kind of a desired process and a process condition.

As described above, the touch panel is used herein. However, instead of this, such a configuration may be used in which a panel only having a display function is used, and the display section is separated from an operation section. Alternatively, such a configuration may also be used in which no key operation section is provided, and the whole of an operation panel 10f is constituted by a display operation section including a touch panel. Thus, the operation panel 10f serves as a user interface for a user who operates the image forming apparatus 1.

The hard disc 10d stores a program, data, and/or the like for realizing functions of e.g., the panel controlling section 111, the image acquisition controlling section 113, the image processing section 114, a sending data generating section 116, and a sending controlling section 117, each shown in FIG. 1.

Such the program is read by the RAM 10b as needed, and is executed by the CPU 10a. Part of or all of such the program or data may be stored in the ROM 10c. Alternatively, part of or all of the functions shown in FIG. 1 may be achieved by the control circuit 10e.

Next, the following describes e.g., a process carried out by each functional section of the image forming apparatus 100 shown in FIG. 1.

The image acquisition controlling section 113 controls hardware such as the scanner unit 10g and the automatic document feeder 10k, for acquiring a document surface image on a document surface of a document sheet constituting papers set on a document setting tray of the automatic document feeder 10k. Once an image is scanned by the scanner unit 10g, the image is sent from the image acquisition controlling section 113 to the panel controlling section 111 and the image processing section 114.

The panel controlling section 111 controls the display operation section 502 in the operation panel 10f. Further, the panel controlling section 111 includes a preview image generating section 111a, a display controlling section 111b, and an instruction acquiring section 111c.

The display controlling section 111b causes the display operation section 502 to display e.g., a screen page through which a message or an instruction is given to a user, a screen page through which a user enters a kind of a desired process and a process condition, or a screen page which shows a result of a process carried out by the image forming apparatus 100.

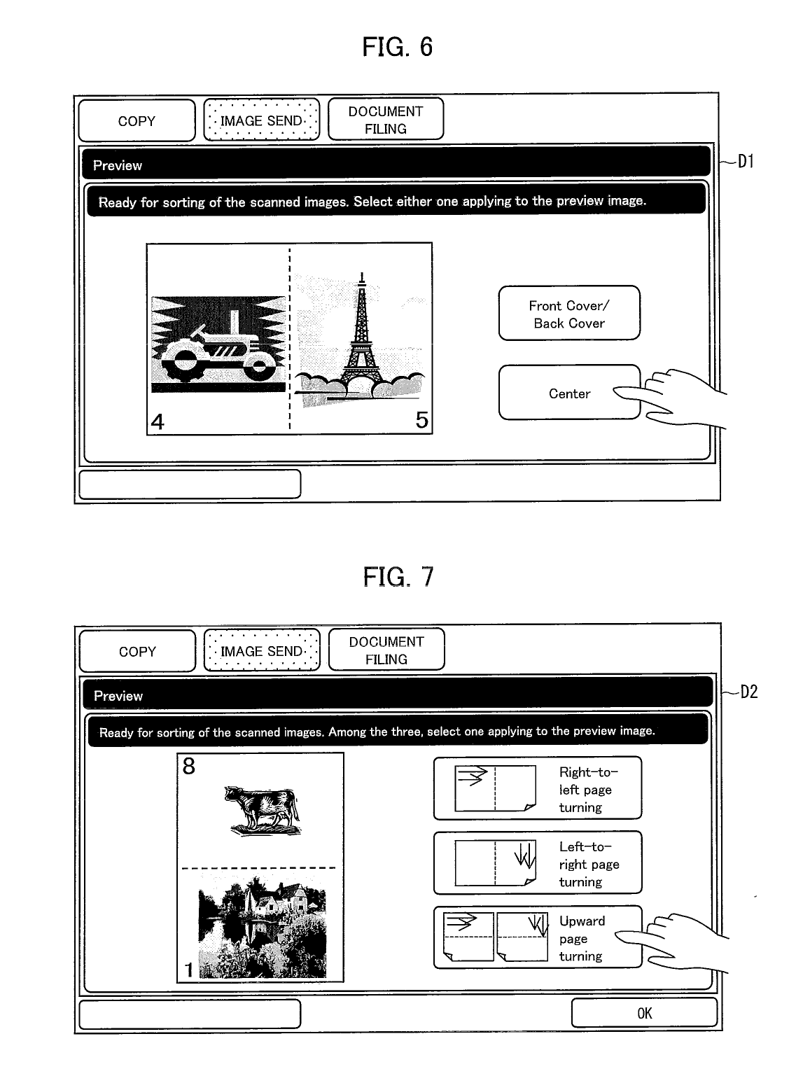

For example, while the display operation section 502 displays an initial menu screen page, a user may press the start key after pressing, as a job key, (i) a displayed key of “IMAGE SEND” and (ii) a displayed key by which a document to be scanned is specified as being “saddle-stitch document”. In response to this, scanning of the document which is set is started. Then, the display controlling section 111b causes display of a scanning start surface specifying screen page D1, as shown in FIG. 6. Here, the scanning start surface specifying screen page D1 includes a preview image of a document image scanned, and allows a user to specify whether the scanning of the document has been started from its front cover/back cover or its center.

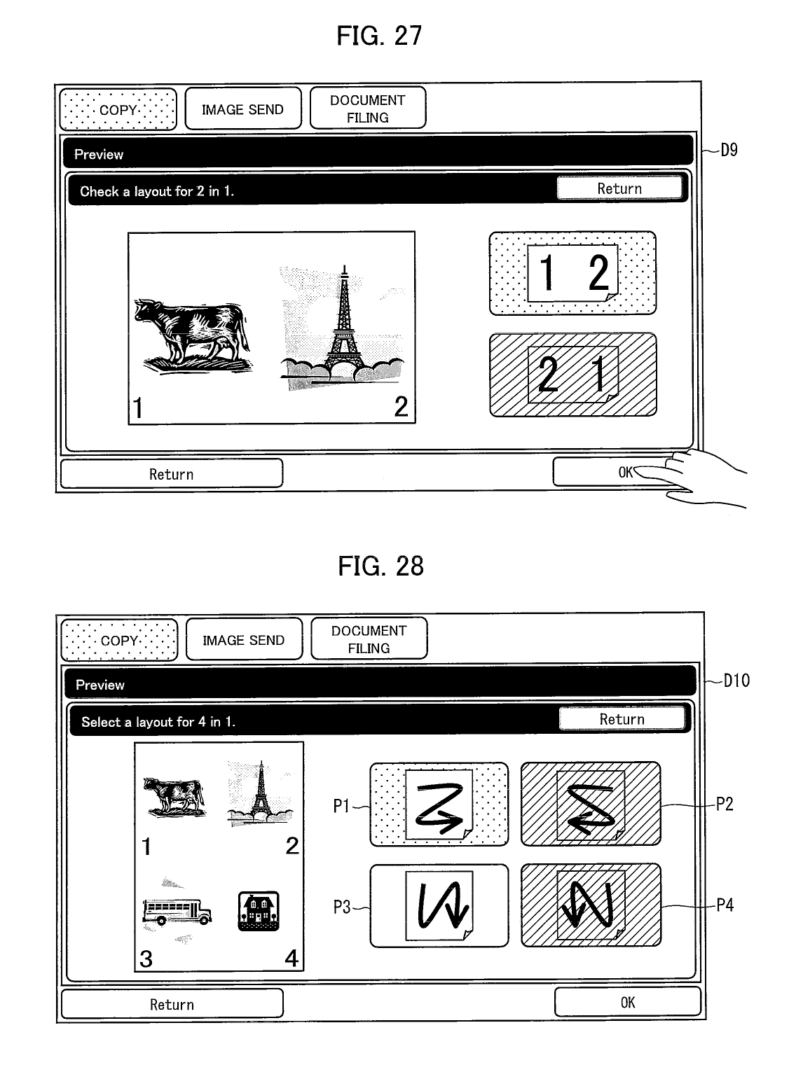

Further, the display controlling section 111b causes display of a screen page allowing the user to select a page turning direction with respect to a printing form for which a layout of page images on a document sheet is selected from among predetermined layout examples. Then, based on the page turning direction selected, the display controlling section 111b extracts a layout example(s) from the predetermined layout examples as a candidate(s), and causes display of a page image layout selecting screen page D9, as shown in FIG. 27, which allows the user to select, from the layout example(s) extracted, a layout example based on which a printing process is to be carried out.

The instruction acquiring section 111c acquires a user's instruction as to e.g., a kind of a desired process and/or a process condition. Here, the instruction is the one entered by (i) user's operation of the screen page on the display operation section 502 or (ii) user's operation of a key in the key operation section 501. Then, the instruction acquiring section 111c outputs the instruction to e.g., the image processing section 114, the sending data generating section 116, and the sending controlling section 117.

The page turning direction selecting means and the page image layout selecting means of the present invention are constituted by the display controlling section 111b and the instruction acquiring section 111c.

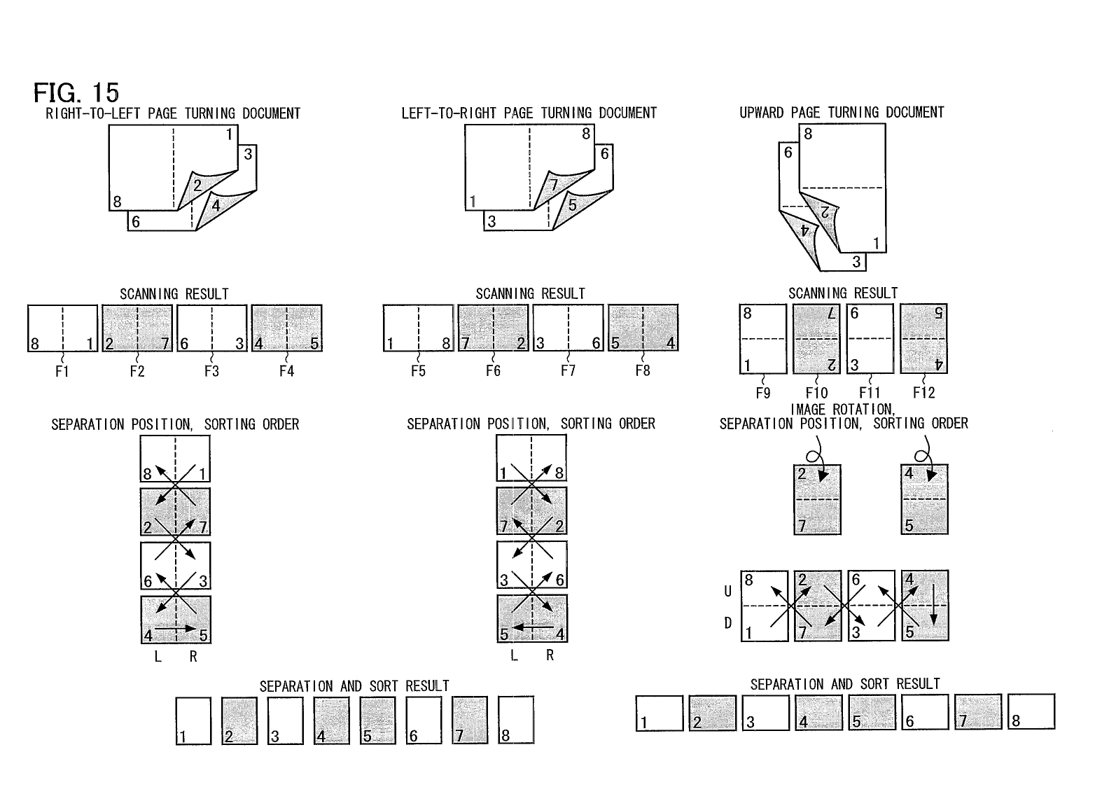

The preview image generating section 111a generates a preview image of a document surface image by using document surface images on respective document surfaces of document sheets constituting papers which document surface images are supplied from the image acquisition controlling section 113. Further, in response to a selection of “Display a preview of the sort result” as a preview display mode, the preview image generating section 111a also generates a preview image showing a sort result, based on image data which have been sorted by page numbers. Here, the image data are the ones supplied from a page image sorting section 114c (described later) in the image processing section 114. The preview image showing the sort result includes, for example, a separation and sort result illustrated at the bottom of FIG. 15 to FIG. 18 (described later).

The preview image display controlling means of the present invention is constituted by the preview image generating section 111a, the display controlling section 111b, and the instruction acquiring section 111c.

The image processing section 114 carries out various kinds of imaging processes on the document surface images on the respective document surfaces of the document sheets constituting the papers which document surface images are supplied from the image acquisition controlling section 113. Further, the image processing section 114 herein includes a rotation processing section 114a, an image separating section 114b, the page image sorting section 114c, and an image editing section 114d.

The rotation processing section 114a carries out a rotation process on the document surface images on the respective document surfaces of the document sheets constituting the papers, if necessary. The image separating section 114b separates each of the document surface images on the respective document surfaces of the document sheets constituting the papers, into the ones each including a content corresponding to one page. For example, in a case where the document surface image is of a 2 in 1 document, which is a document having been subjected to 2 in 1 printing, the image separating section 114b separates the document surface image into two each including an image showing a content corresponding to one page.

The page image sorting section 114c sorts, by page numbers of the papers, page images of the document surface images on the respective document surfaces of the document sheets constituting the papers. Here, the page images are the ones given by the separation carried out by the page image extracting section 114b so that each of the page images shows a content corresponding to one page.

In response to an instruction as to editing given by a user, the image editing section 114d edits the page images of the document surface images on the respective document surfaces of the document sheets constituting the papers. Here, the page images are the ones that the page image sorting section 114c has sorted by page numbers. The editing is carried out so that the page images become suitable for another printing form, e.g., N in 1 printing, saddle stitch printing, or two-sided printing. If no editing is necessary, the image editing section 114d causes the image data supplied from the page image sorting section 114c to simply pass by, and outputs the image data to the printing unit 10h or the sending data generating section 116.

The sending data generating section 116 binds, into one file, the page images of the document surface images on the respective document surfaces of the document sheets constituting the papers. Thus, a document file to be sent is generated. Here, the page images are the ones which have been supplied from the image processing section 114. A format of the document file is determined by a selection made through the instruction acquiring section 111c. Examples of the format encompass PDF (Portable Document Format) and TIFF (Tagged Image File Format).

The sending controlling section 117 controls the above-described communication interface 10j. Further, the sending controlling section 117 sends, to a destination designated through the instruction acquiring section 111c, the document file to be sent that the sending data generating section 116 has generated. Examples of the destination encompass a server device and another image forming apparatus each of which is connected with the image forming apparatus 100 through the communication interface 10j.

Alternatively, the following configuration is also possible: the image processing section 114 compresses the image data which have been subjected to sorting and an editing process; thereafter, the compressed data are attached to an e-mail after a user selects and sets a desired destination from among e-mail destinations stored in advance in a storing section, and then the e-mail is sent via a network communicating section. Further alternatively, the following configuration is also possible: a FAX sending section is provided, and the image data having been subjected to sorting and an editing process are sent by FAX to a certain destination selected by the user. Still alternatively, the following configuration is also possible: the image data having been subjected to sorting and an editing process are stored in (i) a predetermined server on a network or (ii) a HDD or the like included in the image forming apparatus 100. These alternative configurations are not described in detail herein.

Next, the following description deals with a process, carried out by the image forming apparatus 100 of the present embodiment, in which a saddle-stitch document to be processed by the image forming apparatus 100 is scanned and then is copied or sent in another form.

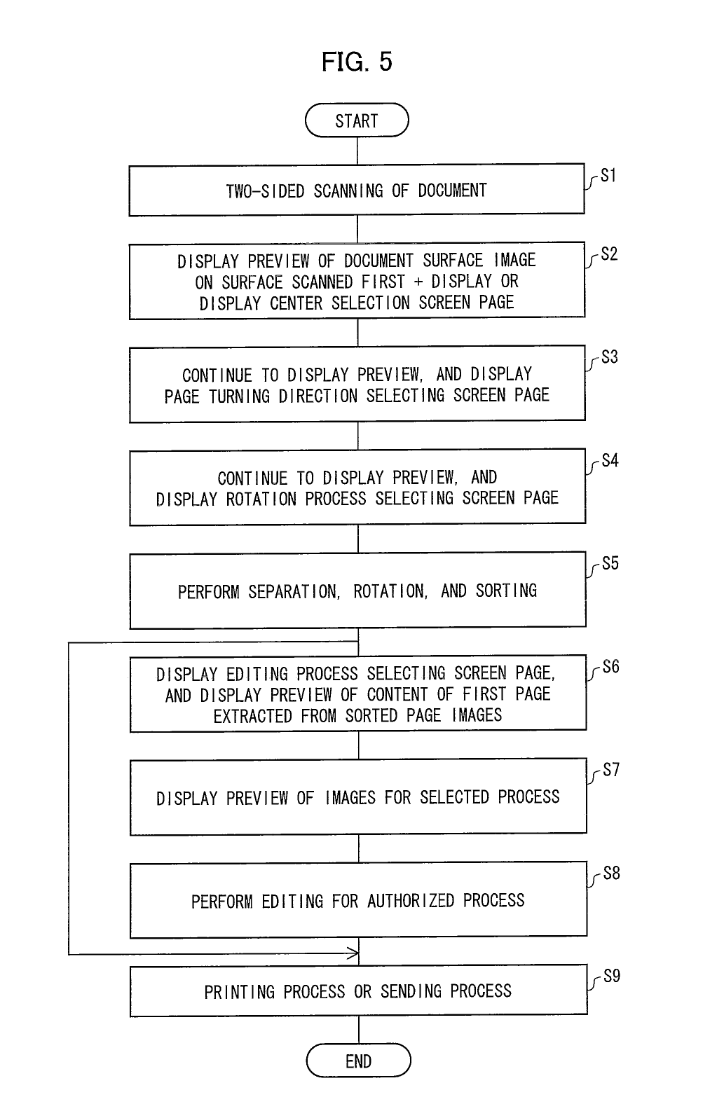

FIG. 5 illustrates a flow in which a saddle-stitch document is scanned and then is copied or sent in another form.

As described above, while a document is set on the document set tray and the initial menu screen page is displayed on the display operation section 502, pressing the start key after pressing e.g., (i) the displayed key of “IMAGE SEND” and (ii) a displayed key by which a document to be processed is specified as being “saddle-stitch document” starts two-sided scanning of the document (S1).

Upon completion of the scanning of the document, the panel controlling section 111 causes the display operation section 502 to display the scanning start surface specifying screen page which allows a user to specify whether the scanning of the document has been started from its front cover/back cover or its center. Here, the present embodiment has a preview display function. Therefore, in accordance with the image data of the document image scanned, the display operation section 502 displays a scanning start surface specifying screen page D1 with a preview, as in FIG. 6 (S2). Here, the scanning start surface specifying screen page D1 includes a preview image showing a content of an image on a surface from which the scanning has been started.

Such a scanning start surface specifying screen page with a preview is displayed in the following manner: In response to an instruction given by the panel controlling section 111, the image acquisition controlling section 113 causes a document to be scanned. Subsequently, based on image data of document surface images, the preview image generating section 111a generates a preview image of a document surface image of a surface scanned first, and then the display controlling section 111b causes the display operation section 502 to display the preview image thus generated.

A user can press a displayed key in the scanning start surface specifying screen page D1 with the preview as in FIG. 6, for specifying whether the scanning of the document has been started from its front surface/back surface or its center.

Assume that a side from which scanning is started is fixed to one of e.g., a front cover/back cover and a center. In such a case, if a saddle-stitch document is placed on the document set tray with its front cover/back cover facing a wrong direction (up or down), rescanning of the document may be required, or a user may not notice that the document is placed facing the wrong direction and consequently the document is scanned and processed in the wrong state. On the other hand, the above configuration of the present embodiment eliminates the need for rescanning of a saddle-stitch document, independently of the direction (up or down) of the front cover/back cover of the saddle-stitch document with respect to the document set tray.

In addition, since the specifying screen page D1 herein displays the preview image of the document surface image on the surface scanned first, a user can easily figure out whether the scanning of the document has been started from its front cover/back cover or it center, and therefore can easily make a selection.

Upon user's selection of the scanning start surface of the document, the panel controlling section 111 causes the display operation section 502 to display a page turning direction specifying screen page D2 with a preview, as in FIG. 7 (S3). Here, the page turning direction specifying screen page D2 includes a preview image of the scanned document image, and allows the user to specify whether the saddle-stitch document is of right-to-left page turning, left-to-right page turning, or upward page turning.

The user can press a displayed key in the page turning direction specifying screen page D2 with the preview as in FIG. 7, for specifying whether the document to be processed is of right-to-left page turning, left-to-right page turning, or upward page turning.

Further, since the specifying screen page D2 herein also displays the preview image of the document surface image on the surface scanned first, the user can easily figure out whether the scanned document is of right-to-left page turning, left-to-right page turning, or upward page turning, and therefore can easily make a selection. Note that the preview display function is not an essential element of the present invention, and a page turning direction specifying screen page may be the one not including a preview image.

For example, in the specifying screen page D2 shown in FIG. 7 as an example, contents corresponding to two pages are vertically aligned across a saddle stitch line. By seeing such the preview image, the user can easily figure out that the document to be processed is of upward page turning, and therefore can select a displayed key for upward page turning.

Thus, since the specifying screen page D2 also displays the preview image of the document surface image on the surface scanned first, the user can easily figure out whether the scanned document is of right-to-left page turning, left-to-right page turning, or upward page turning, and therefore can easily make a selection.

In the preview image displayed in the specifying screen page D1 shown in FIG. 6, the images are aligned side by side across a saddle stitch line, and a content to which a smaller page number is assigned is displayed on the left side. This shows that the scanned document is of right-to-left page turning. In a case of a document of left-to-right page turning, a content to which a smaller page number is assigned is displayed on the right side.

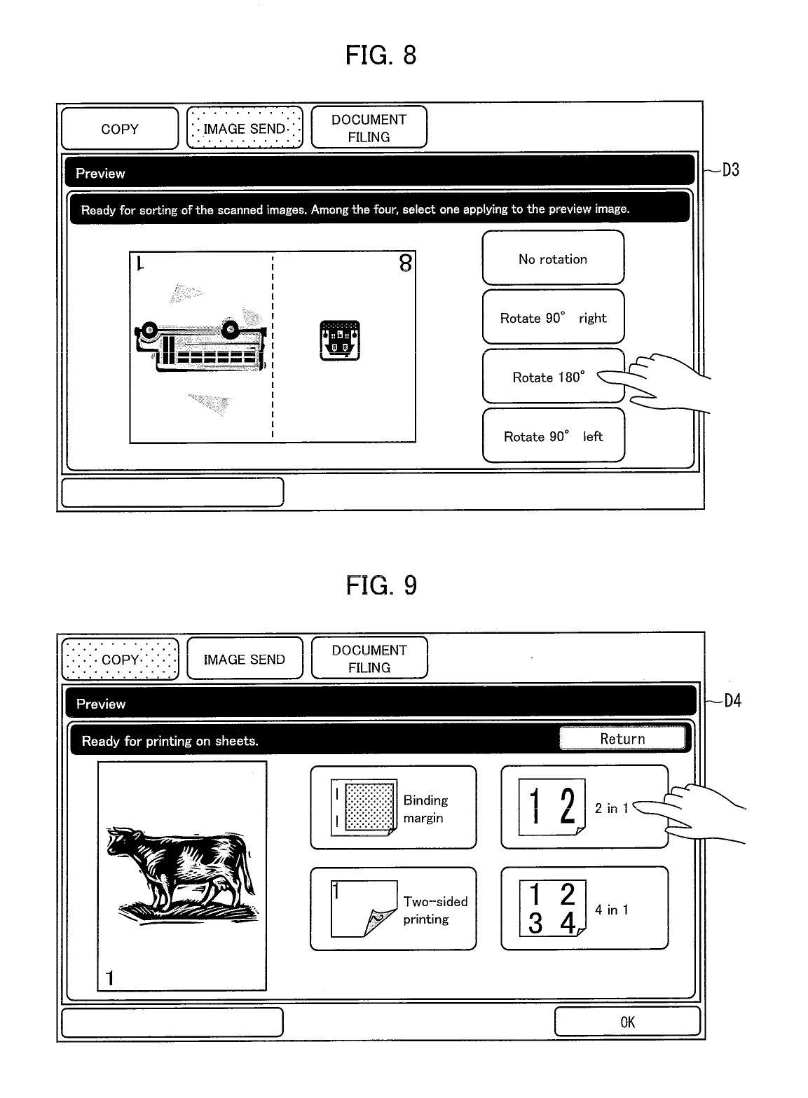

Next, upon user's selection of the page turning direction, the panel controlling section 111 causes the display operation section 502 to display a rotation process selecting screen page D3 with a preview, as in FIG. 8 (S4). Here, the rotation process selecting screen page D3 includes a preview image of the scanned document image, and allows the user to select a rotation process for correction of an orientation of the scanned image of the saddle-stitch document.

In the rotation process selecting screen page D3 with the preview as in FIG. 8, the user can make a selection by pressing any one of displayed keys of “No rotation”, “Rotate 90° right”, “Rotate 180°”, and “Rotate 90° left”.

As well as the selecting screen pages described above, the selecting screen page D3 herein also displays the preview image of the document surface image on the surface scanned first. This allows the user to easily figure out which rotation process is required for the scanned image, and therefore to easily make a selection.

For example, in the selecting screen page D3 shown in FIG. 8 as an example, contents corresponding to two pages are aligned side by side, and an upside (downside) direction of these contents is reverse to an upside (downside) direction (up-to-down direction) of the display operation section 502. Here, the upside (downside) direction (up-to-down direction) of the display operation section 502 is identical to that of letters included in a displayed key. By seeing such the preview image, the user can easily figure out that a 180°-rotation process is required for the scanned image, and therefore can select the displayed key for 180°-rotation process.

Thus, the selecting screen page D3 also displays the preview image of the document surface image on the surface scanned first. This allows the user to easily figure out which rotation process is required for the scanned document, and therefore to easily make a selection.

Through S2 to S4, the scanning start surface, the page turning direction, and the required rotation process are determined for the saddle-stitch document. In response to this, the rotation processing section 114a in the image processing section 114 carries out a rotation process on the document surface images if necessary, the image separating section 114b separates each of the document surface images into page images each including a content corresponding to one page, and the page image sorting section 114c sorts, by page numbers, the page images given by the separation carried out by the image separating section 114b (S5). The rotation process (if necessary), the image separation, and the sorting process each of which is carried out in S5 will be described in detail later.

When the sorting is completed in S5, the panel controlling section 111 displays a screen page (not illustrated) which allows the user to select whether to subject the images thus sorted to an editing process.

Further, in a case where a mode “Display a preview of the sort result” is selected as a preview display mode as described above, the above screen page also displays a preview image showing the sort result based on the image data which have been sorted by page numbers.

If the user selects “No editing process” at this stage, the procedure proceeds to S9, so that the image data are subjected to a printing process or a sending process in the order of the sorting carried out by the page image sorting section 114c. That is, the following process is carried out: (i) the printing unit 10h carries out printing; or (ii) the sending data generating section 116 generates sending data, and the sending controlling section 117 controls the above-described communication interface 10j to send the sending document file thus generated.

On the other hand, if the user selects “Perform editing process”, the panel controlling section 111 causes the display operation section 502 to display an editing process selecting screen page D4 with a preview, as in FIG. 9, for example (S6). Here, the editing process selecting screen page D4 includes a preview of a first page image of the page images sorted by the page image sorting section 114c, and allows the user to make a selection from editing processes.

In the editing process selecting screen page D4 with the preview as in FIG. 9, the user can select an editing process by pressing any one of displayed keys of “Binding margin”, “Two-sided printing”, “2 in 1”, and “4 in 1”. The example shown in FIG. 9 shows a case where copying is selected as a job instead of image-send.

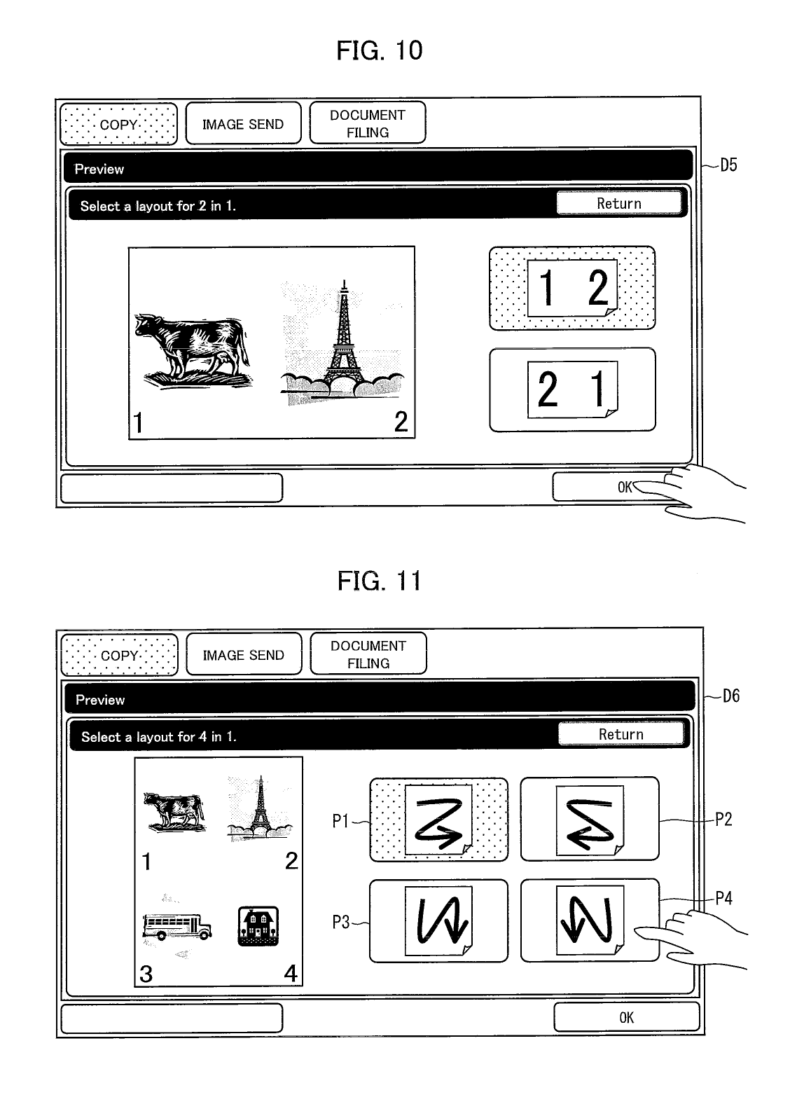

For example, if the displayed key of “2 in 1” is pressed in the selecting screen page D4, the panel controlling section 111 displays a layout selecting screen page D5 with a preview image, as in FIG. 10 (S7). Here, the layout selecting screen page D5 includes a preview image in which (i) a content of the first page image of the sorted page images is arranged on the left and (ii) a content of a second page image of the sorted page images is arranged on the right. Here, a sheet surface is divided into two regions i.e., a left region and a right region. Further, as a default, the content of the first page is arranged in the left region, and the content of the second page is arranged in the right region. Beside the preview image, the displayed keys of “1 2” and “2 1” are displayed, by each of which the layout of the contents is switched from one to another. Of these displayed keys, the displayed key of “1 2” indicative of the layout set in the currently-displayed preview image is grayed out. If the user presses an OK key in this state, the image editing section 114d edits the images so that the images correspond to 2 in 1 printing in which (i) the content of the first page is arranged on the left and (ii) the content of the second page is arranged on the right (S8). Then, the procedure proceeds to S9.

Alternatively, in a case where the displayed key of “2 in 1” is pressed in the layout selecting screen page D5 shown in FIG. 10, the panel controlling section 111 switches the preview image to the one in which (i) the content of the first page image of the sorted page images is arranged on the right and (ii) the content of the second page image of the sorted page images is arranged on the left. If the user presses an OK key in this state, the image editing section 114d edits the images so that the images correspond to 2 in 1 printing in which (i) the content of the first page is arranged on the right and (ii) the content of the second page is arranged on the left (S8). Then, the procedure proceeds to S9.

If the displayed key of “4 in 1” is pressed in the selecting screen page D4 shown in FIG. 9, the panel controlling section 111 causes display of a layout selecting screen page D6 including a preview image, as in FIG. 11 (S7). In the preview image, contents corresponding to four pages i.e., contents of first to fourth page images of the sorted page images are arranged in a default layout. Here, the default layout is as follows: a sheet surface is divided into four regions by lines drawn in the shape of a cross; further, the content of the first page is arranged in an upper left region of the four regions, the content of the second page is arranged in an upper right region of the four regions, the content of the third page is arranged in a lower left region of the four regions, and the content of the fourth page is arranged in a lower right region of the four regions.

Beside the preview image, the four displayed keys P1 to P4 are displayed. Each of these displayed keys is a “Z-shaped arrow”, and switches, from one to another, a layout of contents corresponding to four pages. Each of the arrow keys P1 to P4 does not show any letter, but shows the order in which the contents corresponding to four pages are arranged i.e., an image indicative of editing. In the selecting screen page D6 shown in FIG. 11, the arrow key P1 indicative of the layout set in the currently-displayed preview image is grayed out. If the user presses an OK key in this state, the image editing section 114d edits the images so that the images correspond to 4 in 1 printing in which the four contents are arranged in the default layout (S8). Then, the procedure proceeds to S9.

If the arrow key P4 is pressed in the layout selecting screen page D6 shown in FIG. 11, the panel controlling section 111 switches the preview image to the one in which (i) the content of the first page is arranged in the upper right region, (ii) the content of the second page is arranged in the lower right region, (iii) the content of the third page is arranged in the upper left region, and (iv) the content of the fourth page is arranged in the lower left region.

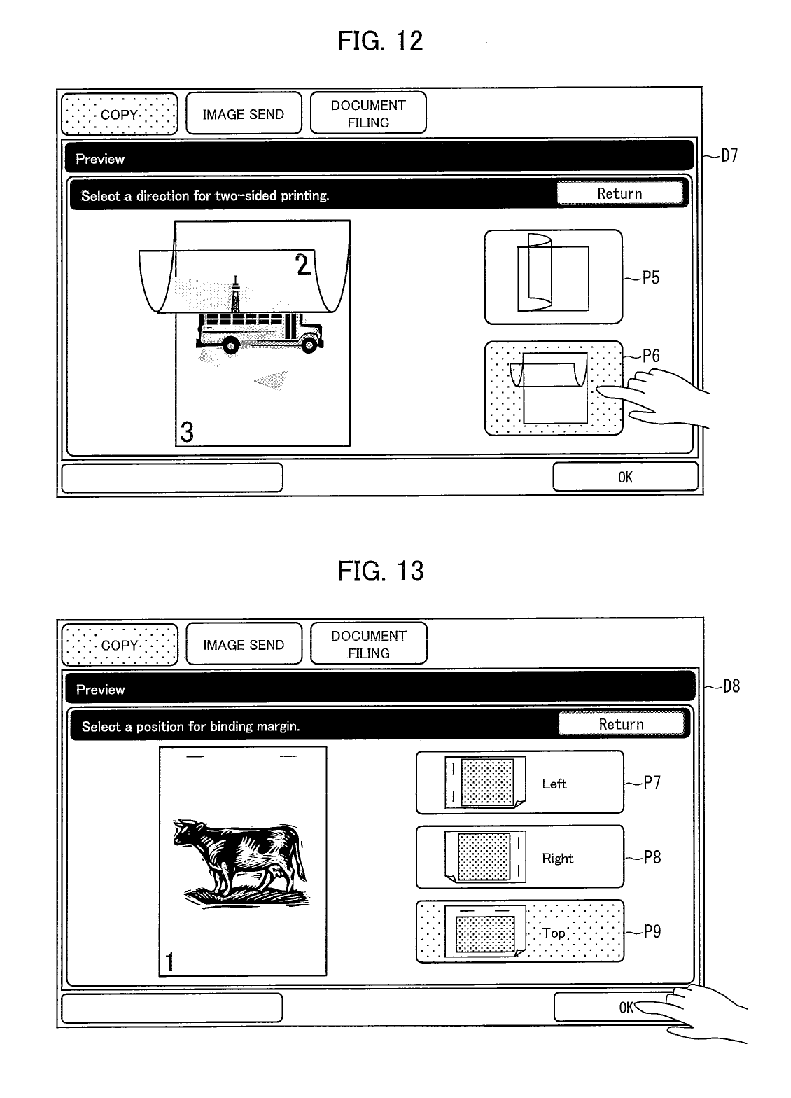

If the displayed key of the “Two-sided printing” is pressed in the selecting screen page D4 shown in FIG. 9, the panel controlling section 111 displays a two-sided printing direction selecting screen page D7, as in FIG. 12 (S7). The two-sided printing direction selecting screen page D7 includes a preview image in which the contents of the second and third page images of the sorted page images are arranged in the form of horizontal binding. Here, horizontal binding is set as a default.

Beside the preview image, the displayed keys P5 and P6 are displayed. The displayed keys P5 and P6 are used for respectively selecting “vertical binding” and “horizontal binding”. Each of the displayed keys P5 and P6 herein does not show any letter, but shows an image indicative of editing. The displayed key P6 indicative of the binding direction set in the currently-displayed preview image is grayed out.

The “vertical binding” is designed to bind, at a vertical side edge, one or more sheets having been subjected to two-sided printing. Further, with “vertical binding”, upside (downside) directions of images respectively depicted on both surfaces of each sheet are the same. On the other hand, the “horizontal binding” is designed to bind, at a top horizontal side edge, one or more sheets having been subjected to two-sided printing. Further, with the “horizontal binding”, upside (downside) directions of images respectively depicted on both surfaces of each sheet are reverse to each other.

If the user presses an OK key in the state of the selecting screen page D7 shown in FIG. 12, the image editing section 114d adjusts upside (downside) directions of respective images on front/back surfaces of each sheet (S8). Then, the procedure proceeds to S9.

Further, if the displayed key P5 is pressed in the selecting screen page D7 shown in FIG. 12, the panel controlling section 111 switches the preview image to the one in which the contents of the second and third page images of the sorted page images are arranged in the form of vertical binding.

On the other hand, if the displayed key of the “Binding margin” is pressed in the selecting screen page D4 shown in FIG. 9, the panel controlling section 111 displays a binding margin position selecting screen page D8, as in FIG. 13 (S7). The binding margin position selecting screen page D8 includes a preview image showing a sheet which includes the content of the first page image of the sorted page images and in which a binding margin is created along its top horizontal side edge. Here, top binding is set as a default in which a binding margin is created along a top horizontal side edge of a sheet.

Beside the preview image, the displayed keys P7 to P9 are displayed. The displayed keys P7 to P9 are used for respectively selecting “left binding”, “right binding”, and “top binding”. Each of the displayed keys P7 to P9 herein shows letters in addition to an image indicative of editing. Of the displayed keys P7 to P9, the displayed key P9 indicative of the binding direction set in the currently-displayed preview image is grayed out.

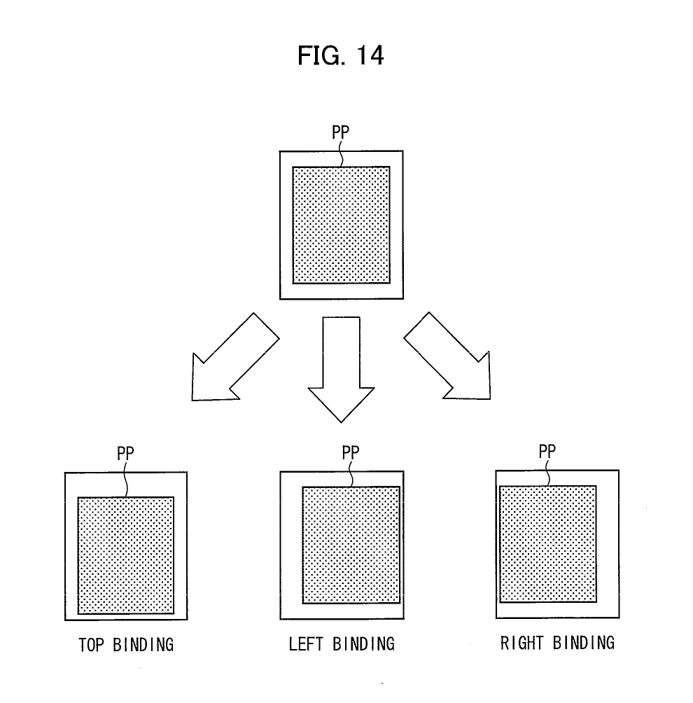

FIG. 14 illustrates how editing for “binding margin” is carried out. For “left binding”, (i) a position of an image PP or (ii) a position and a size of the image PP is adjusted so that a space for a binding margin is created along a left vertical side edge of the sheet. Similarly, for “right binding”, (i) a position of an image or (ii) a position and a size of the image is adjusted so that a space for a binding margin is created along a right vertical side edge of the sheet. For “top binding”, (i) a position of an image or (ii) a position and a size of the image is adjusted so that a space for a binding margin is created along a top horizontal side edge of the sheet.

In a case where the user presses an OK key in the state of the selecting screen page D8 shown in FIG. 13, the image editing section 114d adjusts a position of each image so that a space for a binding margin is created along a top horizontal side edge of each sheet (S8). Then, the procedure proceeds to S9.

Alternatively, in a case where the displayed key P7 is pressed in the selecting screen page D8 shown in FIG. 13, for example, the panel controlling section 111 switches the preview image to the one showing a sheet which includes the content of the first page image of the sorted page images and in which a binding margin is created along its left vertical side edge.

Next, the following describes details of the rotation process, the image separation, and the sorting process each of which is carried out in S5.

Firstly, a sorting process carried out in a case where a document is set on the document set tray 11 in a correct orientation will be described with reference to FIG. 15 to FIG. 18.

FIG. 15 shows examples of a process carried out in a case where a right-to-left-page-turning saddle-stitch document, a left-to-right-page-turning saddle-stitch document, or an upward-page-turning saddle-stitch document is placed on the document set tray 11 with its front cover/back cover facing up. In response to placing of a document on the document set tray 11 with its front cover/back cover facing up, scanning of the document is started from the front cover/back cover. Shown in each of the examples in FIG. 15 is a saddle-stitch document including two two-sided document sheets by which a total of eight pages are given.

Firstly, the right-to-left-page-turning saddle-stitch document will be described. In a case where the right-to-left-page-turning saddle-stitch document including eight pages is scanned from its front cover/back cover, a first document sheet which is scanned first includes, on the right side of its front surface, a content of a first page; and the first document sheet includes, on the left side of its front surface, a content of an eighth page. Further, the first document sheet includes, on the right side of its back surface, a content of a seventh page; and the first document sheet includes, on the left side of its back surface, a content of a second page. Furthermore, a second document sheet which is scanned after the first document sheet includes, on the right side of its front surface, a content of a third page; and the second document sheet includes, on the left side of its front surface, a content of a sixth page. Moreover, the second document sheet includes, on the right side of its back surface, a content of a fifth page; and the second document sheet includes, on the left side of its back surface, a content of a fourth page.

A scanning result of such the document includes: a document surface image F1 in which the content of the eighth page is arranged on the left side and the content of the first page is arranged on the right side; a document surface image F2 in which the content of the second page is arranged on the left side and the content of the seventh page is arranged on the right side; a document surface image F3 in which the content of the sixth page is arranged on the left side and the content of the third page is arranged on the right side; and a document surface image F4 in which the content of the fourth page is arranged on the left side and the content of the fifth page is arranged on the right side.

The image separating section 114b separates image data of each document surface image into two at a binding margin portion thereof. Then, the page image sorting section 114c sorts the separated image data in an ascending order of page numbers starting from the first page. The sorting is carried out according to a sorting order determined by the following conditions: “right-to-left page turning”, which is one of options for the page turning direction; and “front cover/back cover”, which is one of options for the scanning start surface. The arrows in FIG. 15 show the sorting order. For example, in a case where the number of document sheets is N i.e., the number of contents is 2N, the sorting order is as follows: 1_{R}, 2_{L}, 3_{R}, 4_{L}, . . . , (2N−1)_{R}, 2N_{L}, 2N_{R}, (2N−1)_{L}, . . . , 4_{R}, 3_{L}, 2_{R}, 1_{L}, where an image on the left side of an M-numbered image is denoted as M_{L} and an image on the right side of the M-numbered image is denoted as M_{R}. The sort result is illustrated at the bottom of FIG. 15.

On the other hand, in a case where the left-to-right-page-turning saddle-stitch document including eight pages is scanned from its front cover/back cover, a first document sheet which is scanned first includes, on the right side of its front surface, a content of an eighth page; and the first document sheet includes, on the left side of its front surface, a content of a first page. Further, the first document sheet includes, on the right side of its back surface, a content of a second page; and the first document sheet includes, on the left side of its back surface, a content of a seventh page. Furthermore, a second document sheet which is scanned after the first document sheet includes, on the right side of its front surface, a content of a sixth page; and the second document sheet includes, on the left side of its front surface, a content of a third page. Moreover, the second document sheet includes, on the right side of its back surface, a content of a fourth page; and the second document sheet includes, on the left side of its back surface, a content of a fifth page.

A scanning result of such the document includes: a document surface image F5 in which the content of the first page is arranged on the left side and the content of the eighth page is arranged on the right side; a document surface image F6 in which the content of the seventh page is arranged on the left side and the content of the second page is arranged on the right side; a document surface image F7 in which the content of the third page is arranged on the left side and the content of the sixth page is arranged on the right side; and a document surface image F8 in which the content of the fifth page is arranged on the left side and the content of the fourth page is arranged on the right side.

The image separating section 114b separates image data of each document surface image into two at a binding margin portion thereof. Then, the page image sorting section 114c sorts the separated image data in an ascending order of page numbers starting from the first page. The sorting is carried out according to a sorting order determined by the following conditions: “left-to-right page turning”, which is one of options for the page turning direction; and “front cover/back cover”, which is one of options for the scanning start surface. The arrows in FIG. 15 show the sorting order. For example, in a case where the number of document sheets is N i.e., the number of contents is 2N, the sorting order is as follows: 1_{L}, 2_{R}, 3_{L}, 4_{R}, . . . , (2N−1)_{L}, 2N_{R}, 2N_{L}, (2N−1)_{R}, . . . , 4_{L}, 3_{R}, 2_{L}, 1_{R}, where an image on the left side of an M-numbered image is denoted as M_{L} and an image on the right side of the M-numbered image is denoted as M_{R}. The sort result is illustrated at the bottom of FIG. 15.

In a case where the upward-page-turning saddle-stitch document including eight pages is scanned from its front cover/back cover, a first document sheet which is scanned first includes, on the upper side of its front surface, a content of an eighth page; and the first document sheet includes, on the lower side of its front surface, a content of a first page. Further, the first document sheet includes, on the upper side of its back surface, a content of a seventh page; and the first document sheet includes, on the lower side of its back surface, a content of a second page. Furthermore, a second document sheet which is scanned after the first document sheet includes, on the upper side of its front surface, a content of a sixth page; and the second document sheet includes, on the lower side of its front surface, a content of a third page. Moreover, the second document sheet includes, on the upper side of its back surface, a content of a fifth page; and the second document sheet includes, on the lower side of its back surface, a content of a fourth page.

A scanning result of such the document includes: a document surface image F9 in which the content of the first page is arranged on the lower side and the content of the eighth page is arranged on the upper side; a document surface image F10 whose upside (downside) direction is reverse to that of the document surface image F9 and in which the content of the seventh page is arranged on the lower side and the content of the second page is arranged on the upper side; a document surface image F11 in which the content of the sixth page is arranged on the upper side and the content of the third page is arranged on the lower side; and a document surface image F12 whose upside (downside) direction is reverse to that of the document surface images F9 and F11 and in which the content of the fourth page is arranged on the upper side and the content of the fifth page is arranged on the lower side.

Firstly, the rotation processing section 114a rotates by 180° the document surface images F10 and F12 whose upside (downside) direction is reverse to that of the document surface images F9 and F11, so that the upside (downside) directions of the document surface images F9 to F12 are identical to each other. In the case where “upward page turning” is selected as a condition for the page turning direction, the rotation processing section 114a carries out 180°-rotation process on image data of a document surface image depicted on a back surface of a document sheet, as in the manner described above.

The image separating section 114b separates image data of each of the document surface images, whose upside (downside) directions have been made identical, into two at a binding margin thereof. Then, the page image sorting section 114c sorts the separated image data in an ascending order of page numbers starting from the first page. The sorting is carried out according to a sorting order determined by the following conditions: “upward page turning”, which is one of options for the page turning direction; and “front cover/back cover”, which is one of options for the scanning start surface. The arrows in FIG. 15 show the sorting order. For example, in a case where the number of document sheets is N i.e., the number of contents is 2N, the sorting order is as follows: 1_{D}, 2_{U}, 3_{D}, 4_{U}, . . . , (2N−1)_{D}, 2N_{U}, 2N_{D}, (2N−1)_{U}, . . . , 4_{D}, 3_{U}, 2_{D}, 1_{U}, where an image on the upper side of an M-numbered image is denoted as M_{U} and an image on the lower side of the M-numbered image is denoted as M_{D}. The sort result is illustrated at the bottom of FIG. 15.

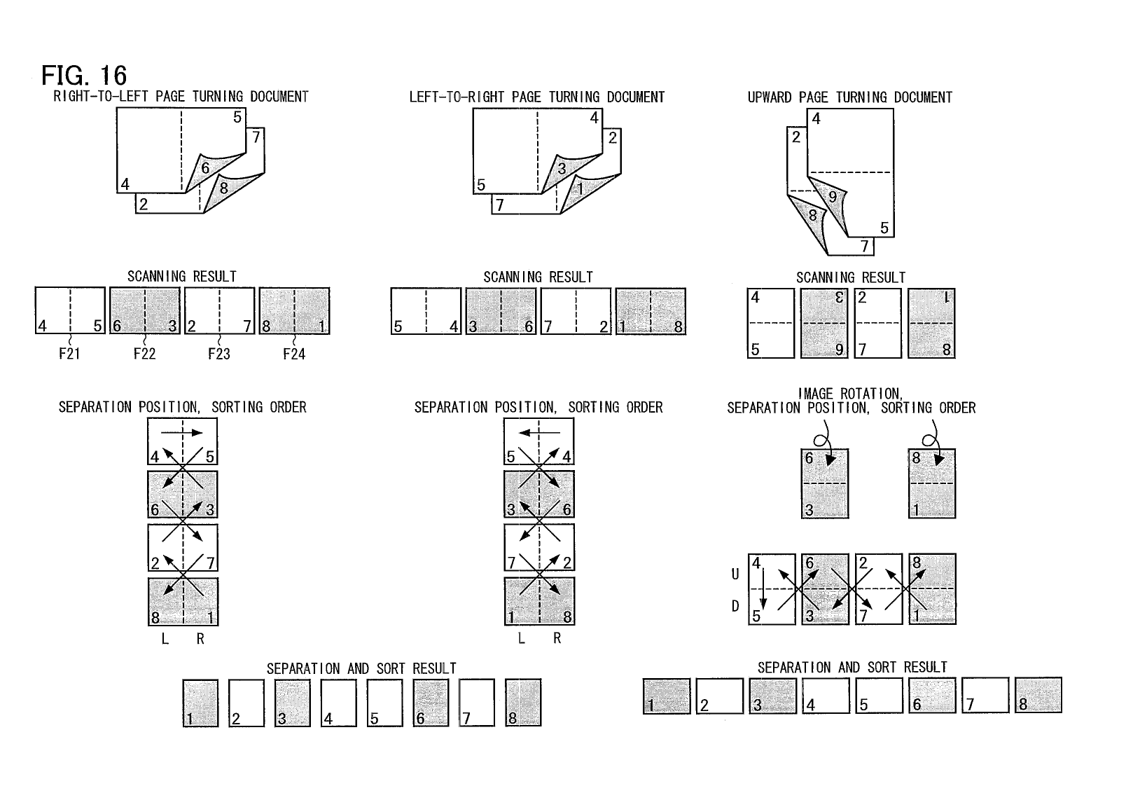

FIG. 16 shows examples of a process carried out in a case where a right-to-left-page-turning saddle-stitch document, a left-to-right-page-turning saddle-stitch document, or an upward-page-turning saddle-stitch document is placed on the document set tray 11 with its center surface facing up. In response to placing of a document on the document set tray 11 with its center surface facing up, scanning of the document is started from the center surface. Shown in each of the examples in FIG. 16 is also a saddle-stitch document including two two-sided document sheets by which a total of eight pages are given. How to read FIG. 16 is the same as that for FIG. 15. Therefore, only a process for the right-to-left-page-turning saddle-stitch document will be explained, and explanations of processes for the left-to-right-page-turning saddle-stitch document and the upward-page-turning saddle-stitch document are omitted here.

In a case where the right-to-left-page-turning saddle-stitch document including eight pages is scanned from its center surface, a first document sheet which is scanned first includes, on the right side of its front surface, a content of a fifth page; and the first document sheet includes, on the left side of its front surface, a content of a fourth page. Further, the first document sheet includes, on the right side of its back surface, a content of a third page; and the first document sheet includes, on the left side of its back surface, a content of a sixth page. Furthermore, a second document sheet which is scanned after the first document sheet includes, on the right side of its front surface, a content of a seventh page; and the second document sheet includes, on the left side of its front surface, a content of a second page. Moreover, the second document sheet includes, on the right side of its back surface, a content of a first page; and the second document sheet includes, on the left side of its back surface, a content of an eighth page.

A scanning result of such the document includes: a document surface image F21 in which the content of the fourth page is arranged on the left side and the content of the fifth page is arranged on the right side; a document surface image F22 in which the content of the sixth page is arranged on the left side and the content of the third page is arranged on the right side; a document surface image F23 in which the content of the second page is arranged on the left side and the content of the seventh page is arranged on the right side; and a document surface image F24 in which the content of the eighth page is arranged on the left side and the content of the first page is arranged on the right side.

The image separating section 114b separates image data of each document surface image into two at a binding margin portion thereof. Then, the page image sorting section 114c sorts the separated image data in an ascending order of page numbers starting from the first page. The sorting is carried out according to a sorting order determined by the following conditions: “right-to-left page turning”, which is one of options for the page turning direction; and “center”, which is one of options for the scanning start surface. The arrows in FIG. 16 show the sorting order. For example, in a case where the number of document sheets is N i.e., the number of contents is 2N, the sorting order is as follows: 2N_{R}, (2N−1)_{L}, . . . , 2_{R}, 1_{L}, 1_{R}, 2_{L}, . . . , (2N−1)_{R}, 2N_{L}, where an image on the left side of an M-numbered image is denoted as M_{L} and an image on the right side of the M-numbered image is denoted as M_{R}. The sort result is illustrated at the bottom of FIG. 16.

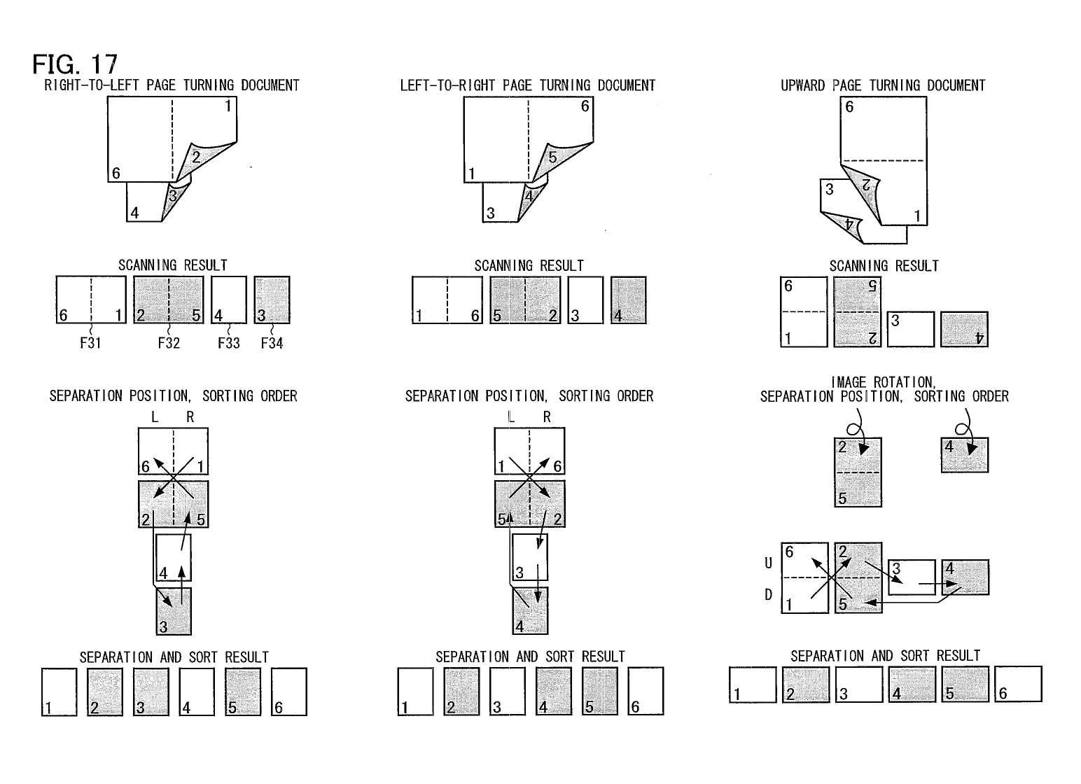

FIG. 17 shows examples of a process carried out in a case where a right-to-left-page-turning saddle-stitch document, a left-to-right-page-turning saddle-stitch document, or an upward-page-turning saddle-stitch document, each of which includes a half-size document sheet (whose size is reduced by half) in its center, is placed on the document set tray 11 with its front cover/back cover facing up. Shown in each of the examples in FIG. 17 is a saddle-stitch document including (i) one two-sided document sheet and (ii) one two-sided document sheet whose size is half of said one document sheet, by both of which document sheets a total of six pages are given. How to read FIG. 17 is the same as those for FIG. 15 and FIG. 16. Therefore, only a process for the right-to-left-page-turning saddle-stitch document including the half-size document sheet will be explained, and explanations of processes for the left-to-right-page-turning saddle-stitch document and the upward-page-turning saddle-stitch document are omitted here.

In a case where the right-to-left-page-turning saddle-stitch document including six pages is scanned from its front cover/back cover, a first document sheet which is scanned first includes, on the right side of its front surface, a content of a first page; and the first document sheet includes, on the left side of its front surface, a content of a sixth page. Further, the first document sheet includes, on the right side of its back surface, a content of a fifth page; and the first document sheet includes, on the left side of its back surface, a content of a second page. Furthermore, a second document sheet which is a half-size document sheet and which is scanned after the first document sheet includes, on its front surface, a content of a fourth page; and the second document sheet includes, on its back surface, a content of a third page.

A scanning result of such the document shows: a document surface image F31 in which the content of the sixth page is arranged on the left side and the content of the first page is arranged on the right side; a document surface image F32 in which the content of the second page is arranged on the left side and the content of the fifth page is arranged on the right side; a document surface image F33 which is half-sized and includes the content of the fourth page; and a document surface image F34 which is half-sized and includes the content of the third page.

The image separating section 114b separates image data of each of document surface image (except for the ones of the half-size document) into two at a binding margin portion thereof. Then, the page image sorting section 114c sorts the separated image data in an ascending order of page numbers starting from the first page. The sorting is carried out according to a sorting order determined by the following conditions: “right-to-left page turning”, which is one of options for the page turning direction; “front cover/back cover”, which is one of options for the scanning start surface; and the presence of a half-size document sheet. Note that the presence or absence of a half-size document sheet can be automatically determined based on the size of image data corresponding to one document sheet scanned.

The arrows in FIG. 17 show the sorting order. For example, in a case where the number of document sheets is N and one of the N document sheets is a half-size document sheet i.e., the number of contents is 2N−2, the sorting order is as follows: 1_{R}, 2_{L}, 3_{R}, 4_{L}, . . . , (2N−2)_{L}, B, A, (2N−2)_{R}, . . . , 4_{R}, 3_{L}, 2_{R}, 1_{L}, where: an image on the left side of an M-numbered image is denoted as M_{L}; an image on the right side of the M-numbered image is denoted as M_{R}; an image on a front surface of the half-size document sheet which is the last to be scanned is denoted as A; and an image on a back surface of the half-size document sheet is denoted as B. The sort result is illustrated at the bottom of FIG. 17.

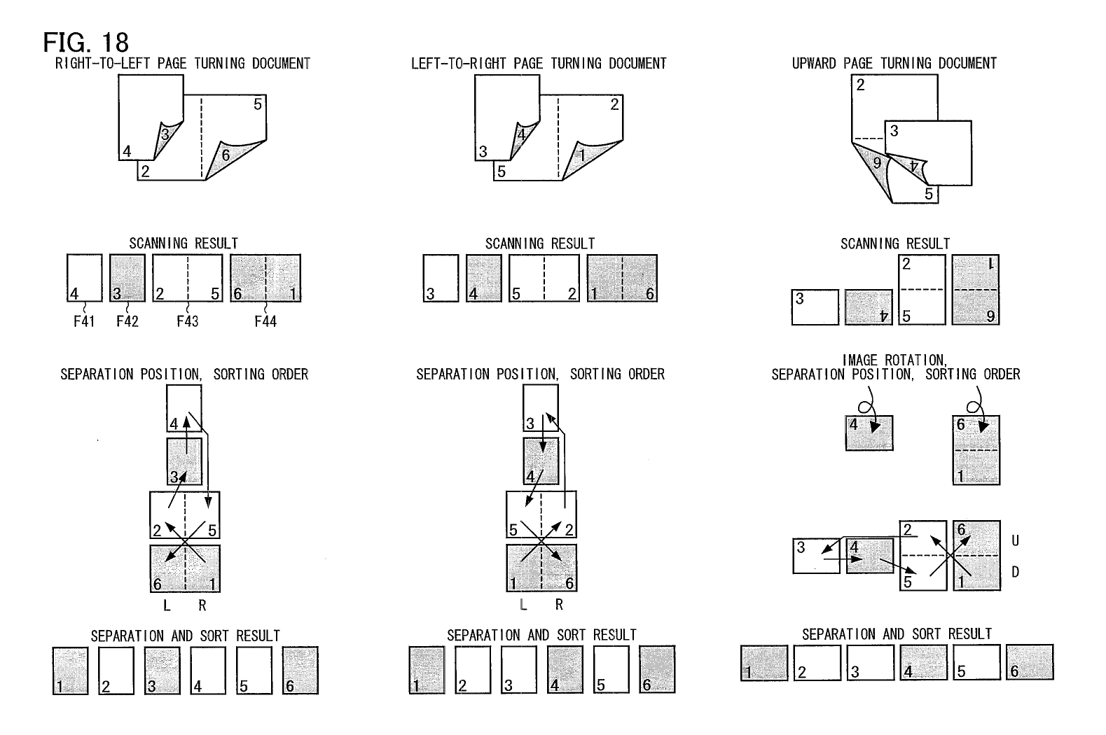

FIG. 18 shows examples of a process carried out in a case where a right-to-left-page-turning saddle-stitch document, a left-to-right-page-turning saddle-stitch document, or an upward-page-turning saddle-stitch document, each of which includes a half-size document sheet (whose size is reduced by half) in its center, is placed on the document set tray 11 with its center surface facing up. Shown in each of the examples in FIG. 18 is a saddle-stitch document including (i) one two-sided document sheet and (ii) one two-sided document sheet whose size is half of said one document sheet, by both of which document sheets a total of six pages are given. How to read FIG. 18 is the same as those for FIG. 15 and FIG. 17. Therefore, only a process for the right-to-left-page-turning saddle-stitch document including the half-size document sheet will be explained, and explanations of processes for the left-to-right-page-turning saddle-stitch document and the upward-page-turning saddle-stitch document are omitted here.

In a case where the right-to-left-page-turning saddle-stitch document including six pages is scanned from its center surface, a first document sheet which is scanned first is the half-size document sheet and includes, on its front surface, a content of a fourth page; and the first document sheet includes, on its back surface, a content of a third page. Further, a second document sheet which is scanned after the first document sheet includes, on the right side of its front surface, a content of a fifth page; and the second document sheet includes, on the left side of its front surface, a content of a second page. Furthermore, the second document sheet includes, on the right side of its back surface, a content of a first page; and the second document sheet includes, on the left side of its back surface, a content of a sixth page.

A scanning result of such the document includes: a document surface image F41 which is half-sized and includes the content of the fourth page; a document surface image F42 which is half-sized and includes the content of the third page; a document surface image F43 in which the content of the second page is arranged on the left side and the content of the fifth page is arranged on the right side; and a document surface image F44 in which the content of the sixth page is arranged on the left side and the content of the first page is arranged on the right side.

The image separating section 114b separates image data of each document surface image (except for the ones of the half-size document) into two at a binding margin portion thereof. Then, the page image sorting section 114c sorts the separated image data in an ascending order of page numbers starting from the first page. The sorting is carried out according to a sorting order determined by the following conditions: “right-to-left page turning”, which is one of options for the page turning direction; “center”, which is one of options for the scanning start surface; and the presence of a half-size document sheet.

The arrows in FIG. 18 show the sorting order. For example, in a case where the number of document sheets is N and one of the N document sheets is a half-size document sheet i.e., the number of contents is 2N−2, the sorting order is as follows: 2N_{R}, (2N−1)_{L}, . . . , 4_{R}, 3_{L}, B, A, 3_{R}, 4_{L}, . . . , (2N−1)_{R}, 2N_{L}, where: an image on the left side of an M-numbered image is denoted as M_{L}; an image on the right side of the M-numbered image is denoted as M_{R}; an image on the front surface of the half-size document sheet which is scanned first is denoted as A; and an image on the back surface of the half-size document sheet is denoted as B. The sort result is illustrated at the bottom of FIG. 18.

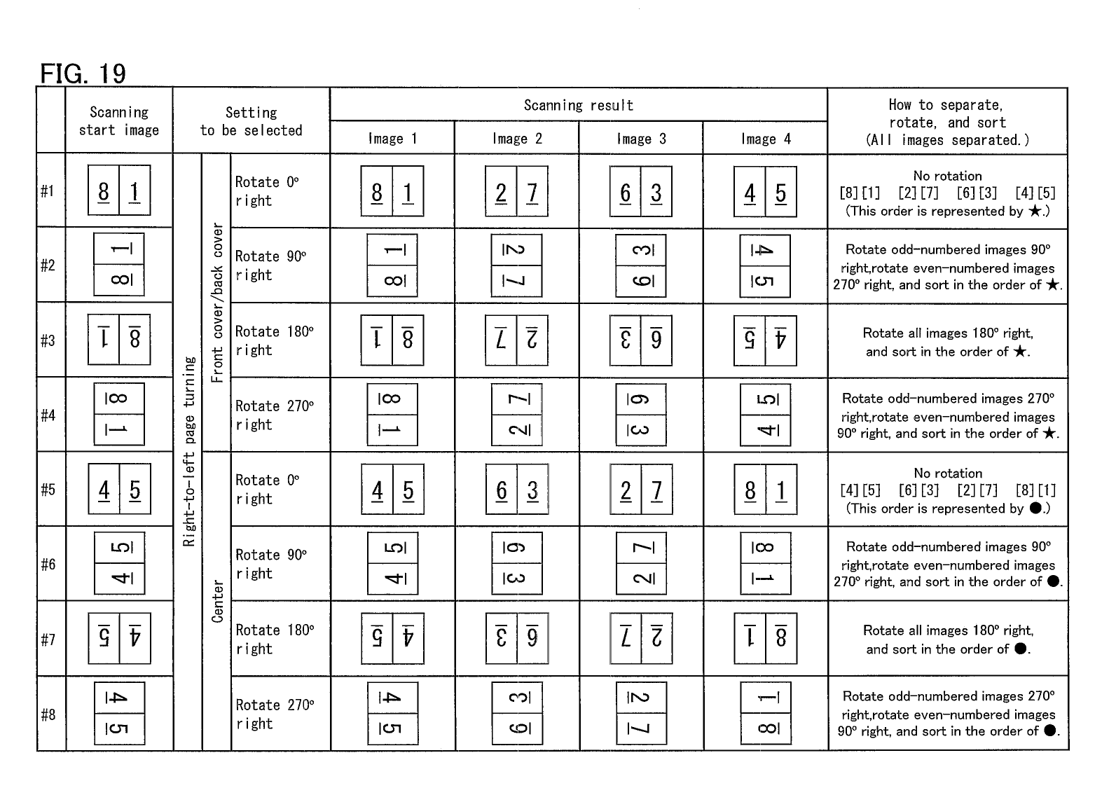

FIG. 19 to FIG. 24 list (i) a scanning start image (i.e., an image on a scanning start surface) displayed in a preview image, (ii) a whole scanning result, (iii) and “page turning direction”, “scanning start surface”, and “rotation process”, which are conditions selected by a user, (iv) and how to carry out separation, rotation, and sorting based on the conditions selected.

All examples shown in FIG. 19 are of a right-to-left-page-turning saddle-stitch document including two two-sided document sheets by which a total of eight pages are given. Of these examples, #1 shows an example where a right-to-left-page-turning saddle-stitch document is set in a correct orientation and is scanned from its front cover/back cover surface. In this case, upon user's selection of “right-to-left page turning”, “front cover/back cover”, and “no rotation”, separation and sorting are carried out in the same manner as that illustrated in FIG. 15 for the process for the right-to-left-page-turning saddle-stitch document. Note that, in FIG. 19, each figure in [ ] (square brackets) in the row of “How to separate, rotate, and sort (All images separated.)” represents a page number of the saddle-stitch document including two two-sided document sheets by which a total of eight pages are given.

On the other hand, #2 in FIG. 19 shows an example where a right-to-left-page-turning saddle-stitch document including two two-sided document sheets by which a total of eight pages are given is wrongly set so that an upside direction of the document points to the left and the document is wider than it is tall. Even in such the case where the document is wrongly set as in this example, by user's selection of “right-to-left page turning”, “front cover/back cover”, and “rotate 90° right”, odd-numbered images, which are document surface images on respective front surfaces of the scanned document sheets, are rotated 90° right, and even-numbered images, which are document surface images on respective back surfaces of the scanned document sheets, are rotated 270° right. Consequently, these images are in the same state as those in #1, in which the document is correctly set. After that, the images are subjected to separation and sorting in the same manner as in #1, in which the document is correctly set.

Here, in the image forming apparatus 100 of the present embodiment, a document sheet is carried in a switchback manner by the document carrying section 101, so that a front surface and a back surface of the document sheet are reversed. As such, in carrying a document sheet in a switchback manner, the front surface and the back surface of the document sheet are reversed (inverted). Not only that, a front edge and a rear edge (in a direction in which the document sheet is carried) of the document sheet are also reversed. Consequently, a document surface image on the back surface of the document sheet is scanned so that its upside (downside) direction is reverse to that of a document surface image on the front surface of the document sheet. In order to deals with this, the document surface image on the front surface of the document sheet is rotated 90° right, whereas the document surface image on the back surface of the document sheet is rotated right by an additional 180° i.e., is rotated right by 270° in total.

Further, #5 in FIG. 19 shows an example where a right-to-left-page-turning saddle-stitch document including two two-sided document sheets by which a total of eight pages are given is scanned from its center surface. In this case, by user's selection of “right-to-left page turning”, “center”, and “no rotation”, separation and sorting are carried out in the same manner as that illustrated in FIG. 16 for the process for the right-to-left-page-turning saddle-stitch document.

On the other hand, #7 shows a case where a right-to-left-page-turning saddle-stitch document including two two-sided document sheets by which a total of eight pages are given is wrongly set so that an upside direction of the document is reversed. Even in such the case where the document is wrongly set as in this example, by user's selection of “right-to-left page turning”, “center”, and “rotate 180°”, all of the scanned document surface images are rotated 180° so as to be in the same state as those in #5, in which the document is correctly set. After that, the images are subjected to separation and sorting in the same manner as in #5, in which the document is correctly set.

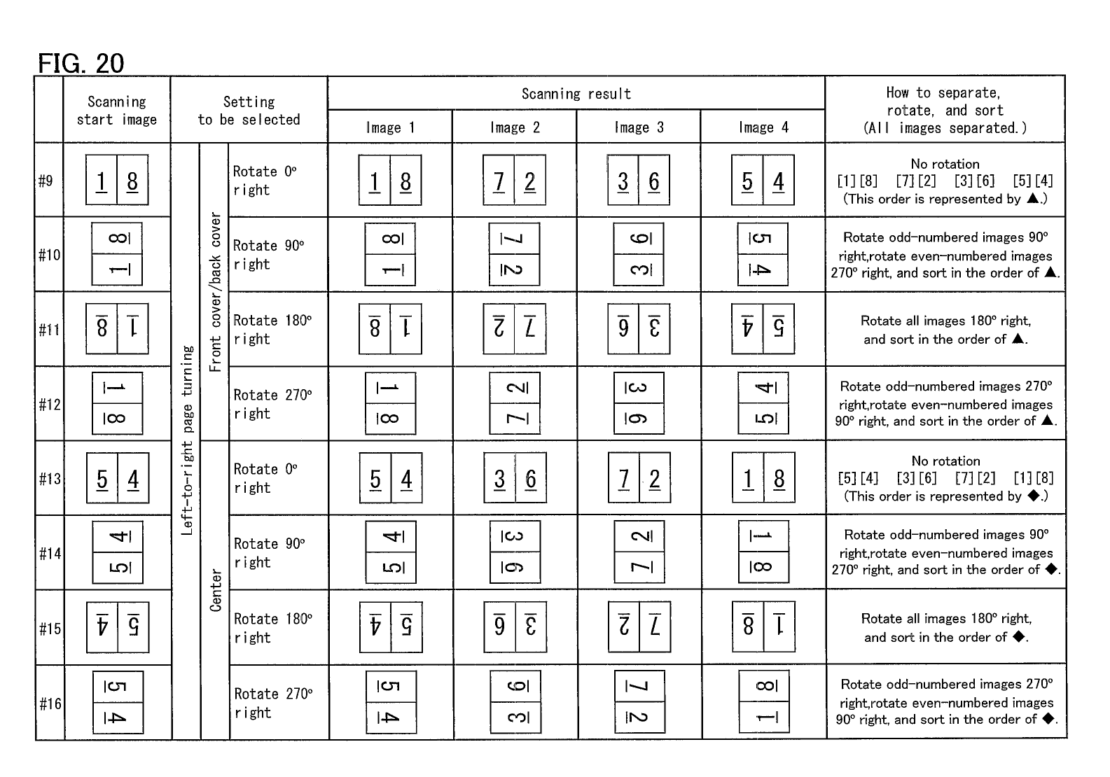

Examples shown FIG. 20 are of a left-to-right-page-turning saddle-stitch document including two two-sided document sheets by which a total of eight pages are given. The examples shown in FIG. 20 are almost the same as those shown in FIG. 19. Therefore, for convenience of explanation, detailed explanations thereof are omitted here.

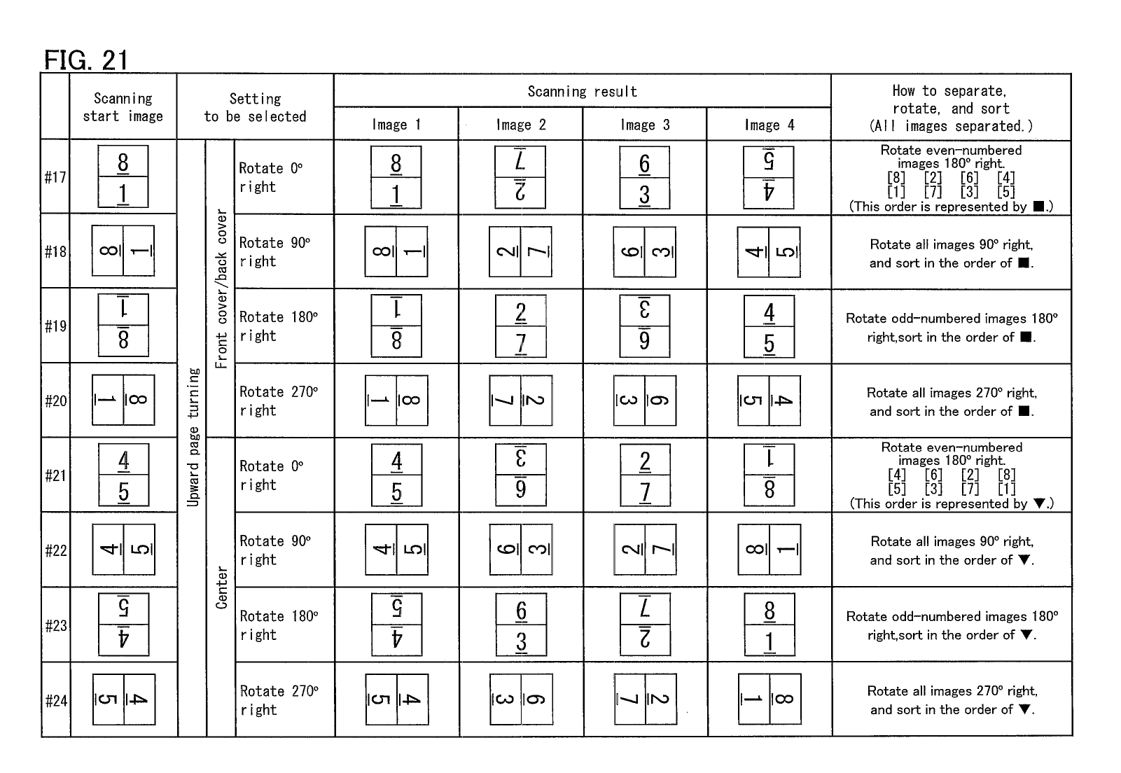

Examples shown in FIG. 21 are of an upward-page-turning saddle-stitch document including two two-sided document sheets by which a total of eight pages are given. Of the examples, #17 shows an example where an upward-page-turning saddle-stitch document is set in a correct orientation and is scanned from its front cover/back cover surface. In this case, upon user's selection of “upward page turning”, “front cover/back cover”, and “no rotation”, separation and sorting are carried out in the same manner as that illustrated in FIG. 15 for the process for the upward-page-turning saddle-stitch document. As described above, in the case of an upward page turning document, an upside (downside) direction of a document surface image on a back surface of a document sheet is reverse to an upside (downside) direction of a document surface image on a front surface of the document sheet. Therefore, image data of the document surface image scanned from the back surface of the document sheet is subjected to a 180°-rotation process.

In FIG. 21, #18 shows an example where an upward-page-turning saddle-stitch document including two two-sided document sheets by which a total of eight pages are given is wrongly set so that an upside direction of the document points to the left and the document is wider than it is tall. Even in the case where the document is wrongly set as in this example, by user's selection of “upward page turning”, “front cover/back cover”, and “rotate 90° right”, all of the scanned document surface images are rotated 90° right. Consequently, the images are in the same state as those in #17, in which the document surface images are scanned from the correctly-set document and are subjected to a required rotation process. After that, the images are subjected to separation and sorting in the same manner as in #17, in which the document is correctly set.

Here, in an upward-page-turning saddle-stitch document, an upside (downside) direction of a document surface image on a back surface of a document sheet is reverse to that of a document surface image on a front surface of the document sheet. Therefore, the document surface image on the back surface of the document sheet should be subjected to a 180°-rotation process. On the other hand, in the image forming apparatus 100 of the present embodiment, a document sheet is carried in a switchback manner by the document carrying section 101, so that a front surface and a back surface of the document sheet are reversed. Therefore, the document surface image on the back surface of the document sheet has already been scanned reversely. Consequently, the 180°-rotation process is no longer necessary. The same applies to #20, #22, and #24 in FIG. 21.

In FIG. 21, #19 shows an example where an upward-page-turning saddle-stitch document including two two-sided document sheets by which a total of eight pages are given is wrongly set so that an upside (downside) direction of the document is reversed. Even in such the case where a document is wrongly set as in this example, by user's selection of “upward page turning”, “front cover/back cover”, and “rotate 180°”, image data of the document surface images scanned from the front surfaces of the document sheets are subjected to a 180°-rotation process. Consequently, the image data can be in the same state as those in #17, in which the document surface images are scanned from the correctly-set document and are subjected to a required rotation process. After that, the image data are subjected to separation and sorting in the same manner as in #17, in which the document is correctly set.

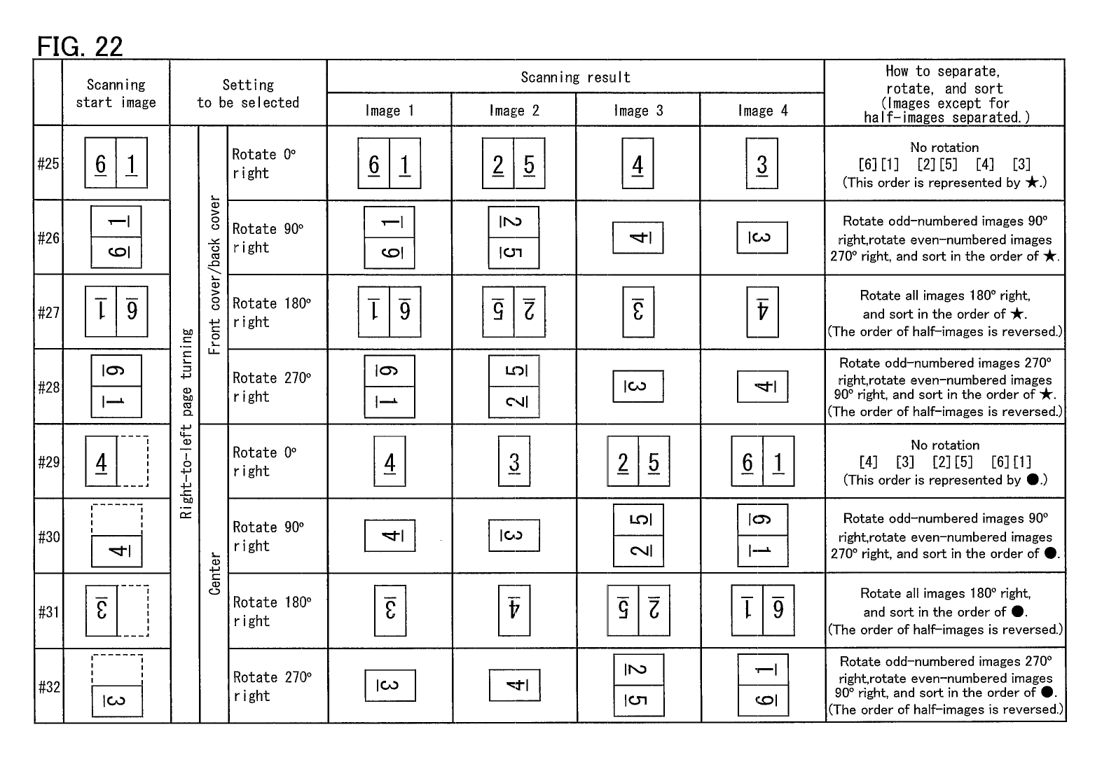

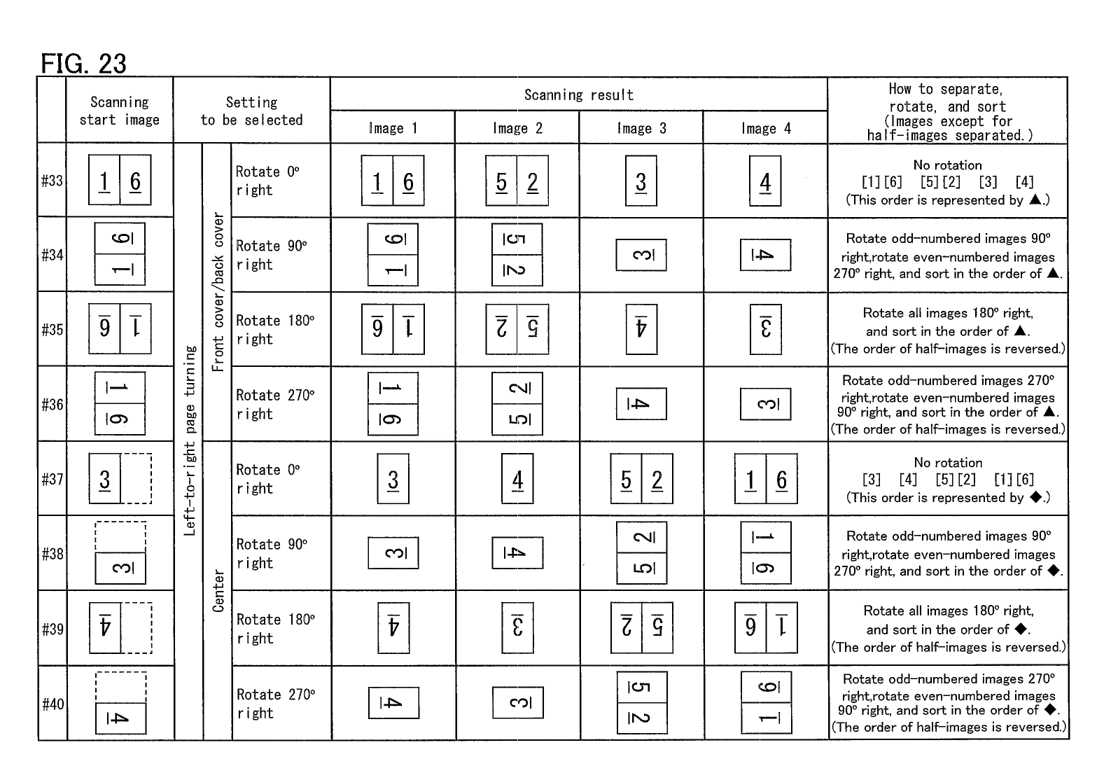

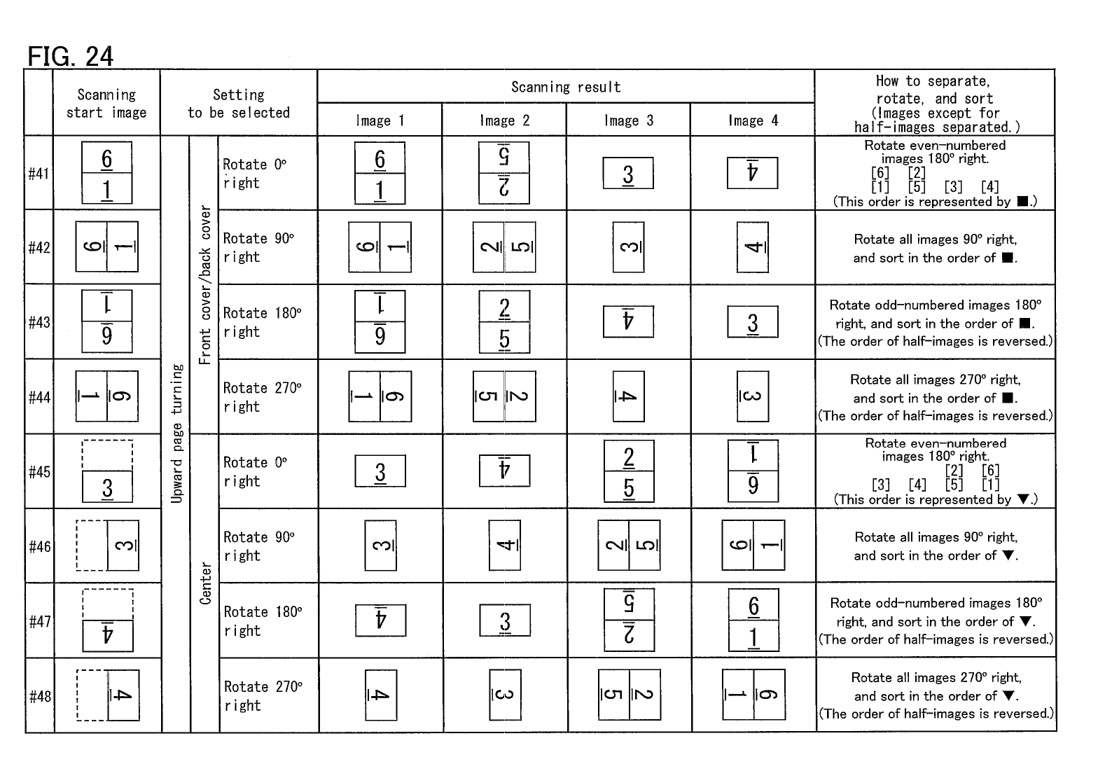

Examples shown in FIG. 22 are of a right-to-left-page-turning saddle-stitch document including two two-sided document sheets. Here, one of the two two-sided document sheets is a half-size document sheet, and the two two-sided document sheets give a total of six pages. Examples shown in FIG. 23 are of a left-to-right-page-turning saddle-stitch document including two two-sided document sheets. Here, one of the two two-sided document sheets is a half-size document sheet, and the two two-sided document sheets give a total of six pages are given. Examples of FIG. 24 are of an upward-page-turning saddle-stitch document including two two-sided document sheets. Here, one of the two two-sided document sheets is a half-size document sheet, and the two two-sided document sheets give a total of six pages are given. Detailed explanations of FIG. 22 to FIG. 24 are omitted here.

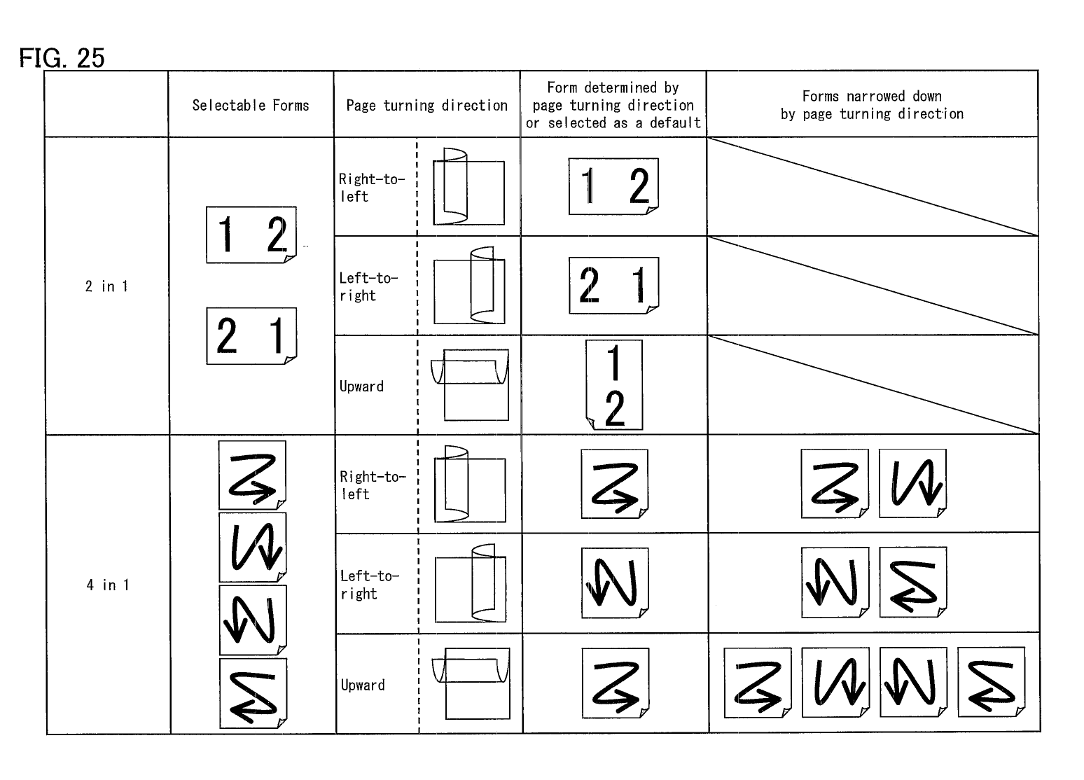

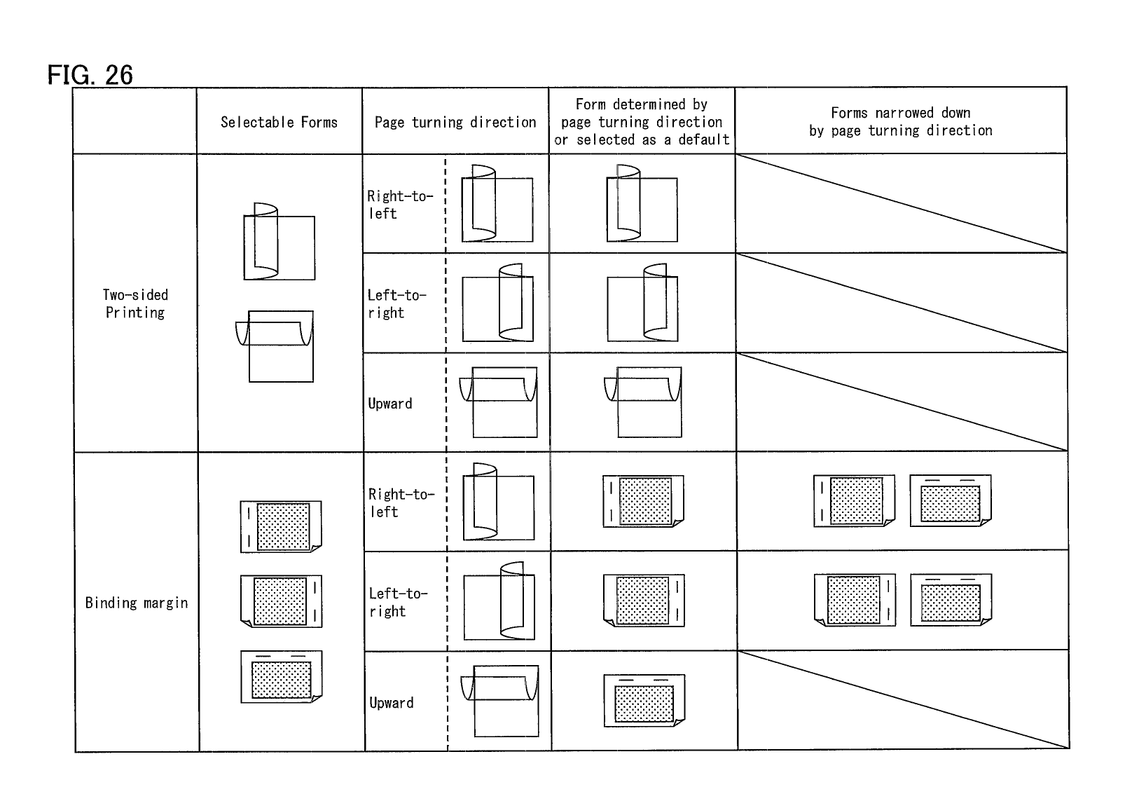

In connection with an editing process (illustrated in FIG. 9 to FIG. 13) to be carried out in S6 with respect to the images which have been sorted, FIG. 25 and FIG. 26 illustrate: selectable forms (layout examples); a page turning direction; a default determined by the page turning direction; and forms narrowed down by the page turning direction.

In FIG. 25, “2 in 1” and “4 in 1” are each presented as an example of the printing form which is selected in an editing process and for which a layout of page images on a sheet is selected from among predetermined layout examples. FIG. 25 explains that, with “2 in 1”, selecting a page turning direction uniquely determines a layout of contents based on the page turning direction thus specified.

That is, selecting “right-to-left page turning” results in display of e.g., a page image layout selecting screen page D9 as shown in FIG. 27. The page image layout selecting screen page D9 not only includes (i) a preview image in which a content of a first page is arranged on the left side and a content of a second page is arranged on the right side and (ii) a message of “Check the layout for 2 in 1.”, but also includes (iii) a displayed key of “1 2” which is displayed as being only a selectable key. A displayed key of “2 1” is grayed out, and cannot be selected. Pressing an OK key in this state ultimately determines a layout. Alternatively, pressing a return key in this state displays again a selecting screen page for selection of a page turning direction.

Alternatively, selecting “left-to-right page turning” results in display of a selecting screen page not only including (i) a preview image in which a content of a second page is arranged on the left side and a content of a first page is arranged on the right side and (ii) a message for prompting a user to check the layout, but also including (iii) a displayed key of “2 1” which is displayed as being only a selectable key. Similarly, selecting “upward page turning” results in display of a selecting screen page not only including (i) a preview image in which a content of a first page is arranged on the upper side and a content of a second page is arranged on the lower side and (ii) a message for prompting a user to check the layout, but also including (iii) a displayed key in which “1 2” is vertically aligned and which is displayed as being only a selectable key.

Such selection of the “page turning direction” is, for example, made as follows: After a user selects “2 in 1” in the editing process selecting screen page D4 with the preview as in FIG. 9, which allows the user to select an editing process, a selecting page screen (e.g., the selecting page screen D2 shown in FIG. 7) is displayed to prompt the user to make a selection as to a “page turning direction”.

On the other hand, for “4 in 1”, selecting “right-to-left page turning” causes the selecting screen page D6 shown in FIG. 11 to display, as a default, a form in which (i) a content of a first page is arranged in the upper left region, (ii) a content of a second page is arranged in the upper right region, (iii) a content of a third page is arranged in the lower left region, and (iv) a content of a fourth page is arranged in the lower right region. That is, the selecting screen page D6 displays the arrow key P1 as a default. Further, of the three other arrow keys P2 to P4, only the arrow key P3 is displayed as being selectable, whereas the arrow keys P2 and P4 are displayed as unselectable or are not displayed. FIG. 28 shows an example of the page image layout selecting screen page displayed for “4 in 1”.

Alternatively, for “4 in 1”, selecting “left-to-right page turning” causes the selecting screen page D6 shown in FIG. 11 to display, as a default, a form in which (i) a content of a first page is arranged in the upper right region, (ii) a content of a second page is arranged in the lower right region, (iii) a content of a third page is arranged in the upper left region, and (iv) a content of a fourth page is arranged in the lower left region. That is, the selecting screen page D6 displays the arrow key P4 as a default. Further, of the other three arrow keys P1 to P3, only the arrow key P2 is displayed as being selectable.

Further alternatively, for “4 in 1”, selecting “upward page turning” causes the selecting screen page D6 shown in FIG. 11 to display the arrow keys P1 to P4 as being selectable. In this case, the default is the arrow key P1.

As such, for “4 in 1”, in a case where four possible layout examples of contents include a layout example unsuitable for the page turning direction (e.g., in the case of “right-to-left page turning” or “left-to-right page turning”), selection of such unsuitable layout example is made impossible. Thus, a user can make a selection from suitable layout examples. This prevents printing failure caused by selection of a layout example unsuitable for the page turning direction, even if the user is unfamiliar with the apparatus. The example shown here is “4 in 1”, however, this configuration is also available for other forms of N=6 or greater, for example, “6 in 1”.

In FIG. 26, “two-sided printing” and “binding margin” are each presented as an example of the printing form which is selected in an editing process and for which a layout of page images on a sheet is selected from among predetermined layout examples. FIG. 26 explains that, for “two-sided printing”, selecting a page turning direction uniquely determines “horizontal binding” or “vertical binding” based on the page turning direction thus specified. For example, selecting “right-to-left page turning” or “left-to-right page turning” uniquely determines vertical binding i.e., causes the selecting screen page D7 shown in FIG. 12 to display only the displayed key P5 of “vertical binding”. Alternatively, selecting “upward page turning” determines horizontal binding i.e., causes the selecting screen page D7 shown in FIG. 12 to display only the displayed key P6 of “horizontal binding”. In “horizontal binding”, an upside (downside) direction of a page image on a front surface of a sheet is reverse to that of a page image on a back surface of the sheet.

For “binding margin”, a page turning direction is selectable. For example, selecting “left binding” causes the selecting screen page D8 shown in FIG. 13 to display, as a default, a form in which a binding margin is created along the left vertical side edge. That is, the selecting screen page D8 displays the displayed key P7 as a default. Further, in this case, of the other displayed keys P8 and P9, only the displayed key P9 for top binding is displayed as being selectable. Alternatively, selecting “right binding” causes the selecting screen page D8 shown in FIG. 13 to display, as a default, a form in which a binding margin is created along the right vertical side edge. That is, selecting screen page D8 displays the displayed key P8 as a default. Further, in this case, of the other displayed keys P7 and P9, only the displayed key P9 for top binding is displayed as being selectable. Further alternatively, selecting “upward page turning” uniquely determines a form in which a binding margin is created along the top horizontal side edge. In this case, the selecting screen page D8 shown in FIG. 13 displays only the displayed key P9 as being selectable, and does not display any other keys as being selectable.

Also for “two-sided printing” or “binding margin”, selection of the “page turning direction” is, for example, made as follows: After a user selects “two-sided printing” or “binding margin” in the editing process selecting screen page D4 with the preview as in FIG. 9, which allows the user to select an editing process, a selecting page screen (e.g., the selecting page screen D2 shown in FIG. 7) is displayed for prompting the user to make a selection as to a “page turning direction.

Further, also for “two-sided printing” or “binding margin”, in a case where possible layout examples of contents include a layout example unsuitable for the page turning direction, selection of such unsuitable layout example is made impossible. Thus, a user can make a selection from suitable layout examples. This prevents printing failure caused by selection of a layout example unsuitable for the page turning direction, even if the user is unfamiliar with the apparatus.

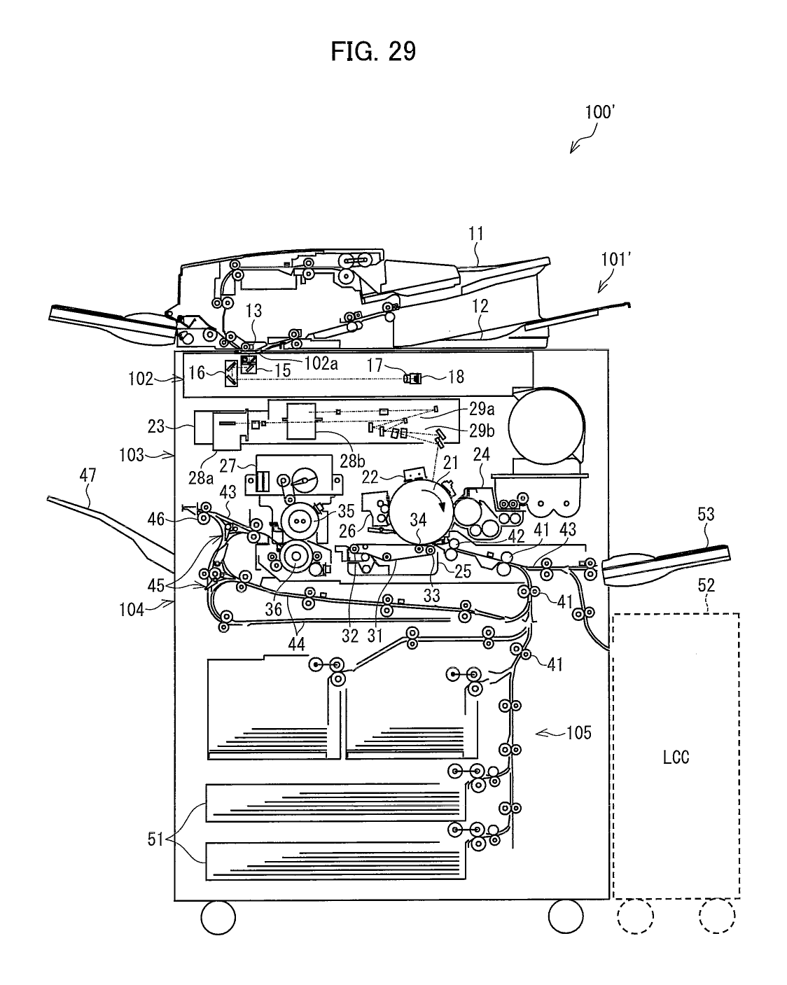

FIG. 29 shows, as another embodiment, an image forming apparatus 100′ including the configuration of the present invention. The image forming apparatus 100′ is different from the image forming apparatus 100 in the document carrying section. The image forming apparatus 100′ includes a document carrying section 101′ capable of dealing with a two-sided document. The document carrying section 101′ is the same as the document carrying section 101 in this point. The document carrying section 101′, however, includes a CIS (Contact Image Sensor) 13 above a document scanning window 102a. In this point, the document carrying section 101′ is different from the document carrying section 101. The CIS 13 repeatedly scans, along a main scanning direction, an image on a back surface of a document sheet set on the document set tray 11 while the document sheet is passing through the document scanning window 102a. Then, the CIS 13 outputs image data indicative of the image on the back surface of the document sheet.

With a configuration where the CIS 13 is provided to scan images on front and back surfaces of a document sheet at the same time, when the CIS 13 scans the right-to-left page turning saddle-stitch document in FIG. 15, document surface images F2 and F4 thus obtained are mirror images (images in a mirror) from the contents of the seventh page and the fifth page. However, the document surface image on the back surface of the document sheet scanned in this manner is temporarily stored in a memory; and reading of the document surface image from the memory is carried out in a direction opposite to a direction in which writing is carried out. Consequently, a scanning result identical to the scanning result shown in FIG. 15 is obtained. Therefore, needless to say, the present invention is applicable to the image forming apparatus 100′ including the CIS 13.

In the foregoing embodiments, each functional section shown in FIG. 1 included in the image forming apparatus 100 is realized by way of software as executed by a processor such as CPU or MPU. Further, as described above, the image forming apparatus 100 includes a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data.

The object of the present invention is achieved by mounting to the image forming apparatus 100 a computer-readable storage medium containing control program code (executable program, intermediate code program, or source program) for the image forming apparatus 100, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a Floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The image forming apparatus 100 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a computer data signal embedded in a carrier wave in which the program code is embodied by electronic transmission.

As described above, in order to solve the foregoing problem, a document image data printing system of the present invention is a document image data printing system for carrying out a printing process with respect to document image data including page image data arranged by page numbers, each of the page image data being image data corresponding to one page, said document image data printing system comprising: page turning direction selecting means for allowing a user to select a page turning direction of a document, which is a printed material to be obtained through the printing process with respect to the document image data; and page image layout selecting means for extracting, based on the page turning direction selected through the page turning direction selecting means, at least one candidate from predetermined layout examples, with respect to a printing for which a layout of at least one page image on a sheet is selected from among the predetermined layout examples, so as to allow the user to make a selection from said at least one candidate extracted.

In this configuration, the page turning direction selecting means allows the user to select the page turning direction of the printed material to be obtained through the printing process with respect to the document image data. The user can select, as the page turning direction, any one of right-to-left page turning, left-to-right page turning, and upward page turning, for example. Further, based on the page turning direction specified through the page turning direction selecting means, the page image layout selecting means extracts at least one candidate from the predetermined layout examples with respect to the printing form for which the layout of at least one page image on the sheet is selected from the predetermined layout examples. Then, the page image layout selecting means allows the user to select a layout example from said at least one candidate extracted.

For the printing form for which the layout of the page images on the sheet is selected from among the predetermined layout examples, some layout examples may be unsuitable for a certain page turning direction. There may be a case where a user unfamiliar with the apparatus selects such the unsuitable layout example, thereby causing printing failure.

In the present invention, the page image layout selecting means extracts, based on the page turning direction selected, at least one candidate from the predetermined layout examples, so as to allow the user to select a layout example from the extracted one(s). This prevents selection of the unsuitable layout example, thereby avoiding printing failure.

It is preferable that the document image data printing system of the present invention further includes: preview image display controlling means for causing a display section to display a preview image based on the page image data, the preview image corresponding to the printing form and showing at least one page image, and the preview image reflecting the layout example of at least one page image, the layout example having been extracted by the page image layout selecting means.

According to this, the preview image display controlling means causes, based on the page image data, the display section to display the preview image corresponding to the printing form and showing at least one page image and said at least one layout example extracted by the page image layout selecting means. With this, before the printing is actually executed, the user can see the preview image and obtain a printing result in an image. Therefore, even by a user unfamiliar with the apparatus, a desired printed material can be obtained more easily.

Examples of the printing form for which the layout of at least one page image on the sheet is selected from among the predetermined layout examples encompass: N in 1 printing by which page images corresponding to N pages are arranged on one sheet; two-sided printing by which page images are respectively formed on both surfaces of a sheet; and printing with binding margin function by which a page image is formed on a sheet while a binding margin is secured along a side edge of the sheet.

The present invention is not limited to the description of the embodiments above, but may be altered by a skilled person within the scope of the claims. An embodiment based on a proper combination of technical means disclosed in different embodiments is encompassed in the technical scope of the present invention.

### REFERENCE SIGNS LIST

100 Image forming apparatus
100′ Image forming apparatus
111 Panel controlling section (page turning direction selecting means, page image layout selecting means, preview image display controlling means)
114 Image processing section (image processing means)
113 Image acquisition controlling section

1. A document image data printing system for carrying out a printing process with respect to document image data including page image data arranged by page numbers, each of the page image data being image data corresponding to one page, said document image data printing system comprising:
page turning direction selecting means for allowing a user to select a page turning direction of a printed material to be obtained through the printing process with respect to the document image data; and
page image layout selecting means for extracting, based on the page turning direction selected through the page turning direction selecting means, at least one layout example from predetermined layout examples as a candidate, with respect to a printing form for which a layout of at least one page image on a sheet is selected from among the predetermined layout examples, so as to allow the user to select, from said at least one layout example extracted, a layout example based on which the printing process is to be carried out.

2. The document image data printing system as set forth in claim 1, wherein:
the printing form is N in 1 printing by which page images corresponding to N pages are arranged on one sheet.

3. The document image data printing system as set forth in claim 1, wherein:
the printing form is two-sided printing by which page images are respectively formed on both surfaces of a sheet.

4. The document image data printing system as set forth in claim 1, wherein:
the printing form is printing with binding margin function by which a page image is formed on a sheet while a binding margin is secured along a side edge of the sheet.

5. The document image data printing system as set forth in claim 1, wherein:
the page turning direction selecting means allows the user to select one of right-to-left page turning, left-to-right page turning, and upward page turning.

6. A document image data printing system for carrying out a printing process with respect to document image data including page image data arranged by page numbers, each of the page image data being image data corresponding to one page, said document image data printing system comprising:
page turning direction selecting means for allowing a user to select a page turning direction of a printed material to be obtained through the printing process with respect to the document image data;
page image layout selecting means for extracting, based on the page turning direction selected through the page turning direction selecting means, at least one layout example from predetermined layout examples as a candidate, with respect to a printing form for which a layout of at least one page image on a sheet is selected from among the predetermined layout examples, so as to allow the user to select, from said at least one layout example extracted, a layout example based on which the printing process is to be carried out; and
preview image display controlling means for causing a display section to display a preview image based on the page image data, the preview image corresponding to the printing form and showing at least one page image and said at least one layout example extracted by the page image layout selecting means.

7. The document image data printing system as set forth in claim 6, wherein:
the printing form is N in 1 printing by which page images corresponding to N pages are arranged on one sheet.

8. The document image data printing system as set forth in claim 6, wherein:
the printing form is two-sided printing by which page images are respectively formed on both surfaces of a sheet.

9. The document image data printing system as set forth in claim 6, wherein:
the printing form is printing with binding margin function by which a page image is formed on a sheet while a binding margin is secured along a side edge of the sheet.

10. The document image data printing system as set forth in claim 6, wherein:
the page turning direction selecting means allows the user to select one of right-to-left page turning, left-to-right page turning, and upward page turning.
